(19) United States
(12) Patent Application Publication
(10) Pub. No.: US 2016/0006640 A1
(43) Pub. Date: Jan. 7, 2016

(54) MANAGEMENT COMPUTER, ALLOCATION MANAGEMENT METHOD, AND NON-TRANSITORY COMPUTER READABLE STORAGE MEDIUM

(71) Applicant: HITACHI, LTD., Chiyoda-ku, Toyota (JP)

(72) Inventors: Mineyoshi MASUDA, Tokyo (JP); Yutaka KUDOU, Tokyo (JP)

(21) Appl. No.: 14/767,663

(22) PCT Filed: Nov. 12, 2013
(86) PCT No.: PCT/JP2013/080507

§ 371 Date: Aug. 13, 2015

(51) Int. Cl. H04L 12/26

(52) U.S. Cl. CPC H04L 43/12; H04L 43/14; H04L 43/16

(57) ABSTRACT

A management computer for managing allocation of an application and an application probe in a computer system including a plurality of computers, the management computer comprising a probe management part configured to determine a computer for allocating a new application and a new application probe, the probe management part being configured to: retrieve a computer satisfying a configuration condition and a monitoring interval condition; compute a value of a monitoring spike, in a case where the new application and the new application probe are allocated to the retrieved computer, determine the retrieved computer as a candidate computer to which the application and the application probe are to be allocated, in a case where it is determined that the computed value of the monitoring spike is smaller than a predetermined threshold.

### BACKGROUND OF THE INVENTION

This invention relates to a management computer that measures the performance of an IT system to monitor whether a failure has occurred.

An IT system is configured to include infrastructure resources including a host computer, a storage apparatus, and switches, and an application that operates using the infrastructure resources.

In the following description, a host computer and the like that constitute infrastructure resources are referred to as element resources. A CPU, a memory, a network interface, and the like that are included in a host computer or the like which is an element resource are referred to as computer resources.

Monitoring probe software that monitors the statuses of element resources such as the host computer, and monitoring probe software that monitors the status of an application run on the IT system.

In the following description, the monitoring probe software that monitors the statuses of element resources is referred to as a resource monitoring probe, and the monitoring probe software that monitors the status of an application is referred to as an application probe. In addition, the resource monitoring probe and the application probe, when they are not distinguished from each other, are referred to simply as probes.

A probe measures the performance of a monitoring target at arbitrary monitoring intervals, and records measured data. The recorded measured data is used in detecting a performance failure and examining the cause of a performance failure. For example, the resource monitoring probe measures the performance of the hardware of the host computer and the performance of a control program such as an OS.

For example, U.S. Pat. No. 6,801,940 discloses how to retrieve and use a probe that satisfies monitoring conditions requested by a user.

### SUMMARY OF THE INVENTION

Grasping a performance failure in an IT system needs monitoring data measured by a plurality of probes at the same timing. When the monitoring intervals of synchronized probes are set shorter, however, a monitoring spike is likely to occur. The monitoring spike represents instantaneous consumption of a large amount of resources in the process of monitoring probes.

However, the technology described in U.S. Pat. No. 6,801,940 cannot achieve shortening of the monitoring intervals of synchronized probes and suppression of occurrence of a monitoring spike originating from the shortening of the monitoring intervals at the same time. Further, the technology described in U.S. Pat. No. 6,801,940 cannot cope with the recent mode of usage of IT systems.

Demands have been made on a technology that achieves the shortening of the monitoring intervals and the suppression of occurrence of a monitoring spike and copes with the mode of usage of IT systems.

The present invention can be appreciated by the description which follows in conjunction with the following figures, wherein: a management computer for managing allocation of an application and an application probe for monitoring a status of the application in a computer system including a plurality of computers, the plurality of computers including at least one computer on which a resource monitoring probe that monitors a status of at least one computer operates. The management computer comprises: a processor; a memory coupled to the processor; a network interface coupled to the processor; and a probe management part configured to determine a computer for allocating a new application and a new application probe requested to perform monitoring in synchronism with a monitoring timing for the resource monitoring probe, based on a monitoring request including a configuration condition for the computer for allocating the new application probe and a monitoring interval condition for the new application probe. The probe management part is configured to: retrieve a computer satisfying the configuration condition and the monitoring interval condition from among the plurality of computers; compute a value of a monitoring spike, in a case where the new application and the new application probe are allocated to the retrieved computer, the monitoring spike being a load generated by the resource monitoring probe and the application probe for performing monitoring in synchronism with the monitoring timing for the resource monitoring probe; determine whether the computed value of the monitoring spike is smaller than a predetermined threshold; and determine the retrieved computer as a candidate computer to which the application and the application probe are to be allocated, in a case where it is determined that the computed value of the monitoring spike is smaller than the predetermined threshold.

This invention can suppress occurrence of a large monitoring spike, and determine where to allocate an application and an application probe that are capable of achieving fine-grained monitoring and synchronized monitoring. Consequently, it is possible to obtain monitored data measured at the synchronized monitoring timings of a plurality of probes as data useful in examining a performance failure.

### BRIEF DESCRIPTION OF THE DRAWINGS

The present invention can be appreciated by the description which follows in conjunction with the following figures, wherein:

FIG. 1 is an explanatory diagram illustrating the outline of an embodiment of this invention;

FIG. 2 is an explanatory diagram illustrating an example of the configuration of an IT system according to the first embodiment;

FIG. 3 is an explanatory diagram showing an example of the configuration of infrastructure configuration information according to the first embodiment;

FIG. 4 is an explanatory diagram showing an example of the configuration of measured data information according to the first embodiment;

FIG. 5 is an explanatory diagram showing an example of the configuration of resource monitoring request information according to the first embodiment;

FIG. 6 is an explanatory diagram showing an example of the configuration of probe configuration information according to the first embodiment;

FIG. 7 is an explanatory diagram showing an example of the configuration of probe restriction information according to the first embodiment;

FIG. 8 is an explanatory diagram showing an example of the configuration of probe monitoring timing information according to the first embodiment

FIG. 9 is an explanatory diagram showing an example of the configuration of probe-load estimating equation information according to the first embodiment;

FIG. 10 is an explanatory diagram showing an example of the configuration of out-of-synchronization statistical information according to the first embodiment;

FIG. 11 is a flowchart illustrating the outline of a process of determining allocation of an application, which is performed by a management computer according to the first embodiment;

FIG. 12 is a flowchart illustrating an example of a filtering process according to the first embodiment;

FIGS. 13A and 13B are explanatory diagrams illustrating an example of a monitoring timing tree 130 according to the first embodiment;

FIG. 14 is a flowchart illustrating a monitoring-interval changing process according to the first embodiment;

FIG. 15 is a flowchart illustrating a monitoring-spike checking process that is performed by the management computer according to the second embodiment

FIG. 16 is a flowchart illustrating a reallocation determining process for the application that is performed by the management computer according to the second embodiment;

FIG. 17 is an explanatory diagram illustrating an example of a monitoring-interval changing screen according to the third embodiment;

FIG. 18 is a flowchart illustrating the monitoring-interval changing process for an application probe 23 that is performed by the management computer according to the third embodiment;

FIG. 19 is an explanatory diagram illustrating an example of a monitoring-interval changing screen 1900 according to the fourth embodiment;

FIG. 20 is a flowchart illustrating a display process that is performed by the management computer according to the fourth embodiment;

FIG. 21 is a flowchart illustrating a monitoring-timing correcting process that is performed by the management computer according to the fifth embodiment; and

FIG. 22 is a flowchart illustrating an estimation-equation generating process that is performed by the management computer according to the sixth embodiment.

### DETAILED DESCRIPTION OF THE PREFERRED EMBODIMENTS

The following requests need to be dealt with in the field of monitoring the performance of an IT system.

(First Request) Fine-Grained Monitoring

Hitherto, the monitoring interval of an ordinary probe is in the order of minutes. While the monitoring interval in the order of minutes suffices for rough isolation of a component that has a performance failure, such monitoring interval is insufficient to accurately specify the cause of a performance failure. It is therefore desired to cope with a monitoring interval in the order of seconds finer than the monitoring interval in the order of minutes.

(Second Request) Synchronization of Monitoring Timing

In a case where a plurality of probes are operated to monitor an IT system, there is a demand of synchronizing the monitoring timings of the individual probes, namely, of performing monitoring at the same timing. Suppose that a database probe that monitors a database and a host probe (one of resource monitoring probes) that monitors a host computer on which the database operates are each performing monitoring at intervals of three seconds.

It is assumed that the database probe has detected a performance failure from measured data. Analysis of determining whether the performance failure is caused by an element resource (host computer) needs measured data on the host computer measured at the same monitoring timing as that of the database probe. In other words, the monitoring timing of the database probe needs to be synchronized with that of the host probe.

(Third Request) Compatibility with Cloud

Cloud computing is advancing as the mode of usage of IT systems. In other words, infrastructure resources are managed as a shared pool, necessary resources are separated from the infrastructure resources in accordance with the configuration of a business system requested by a user, and the separated resources are allocated to the business system.

In a case where a user requests monitoring that satisfies (First Request) and (Second Request) at the same time as making a resource request for a business system, it is required to retrieve and allocate resources satisfying the resource request and the monitor request.

In the IT system satisfying (First Request), monitoring of the fine grain of probes increases the number of measurements. In the IT system satisfying (Second Request), the number of probes that make measurements at a predetermined timing increases.

Therefore, in the IT system satisfying (First Request) and (Second Request) at the same time, the synchronized monitoring of the probes is apt to cause a monitoring spike. A large monitoring spike, even if occurred temporarily, affects the smooth operations of other applications.

In the conventional silo use of separating infrastructure resources for each IT system, an infrastructure manager and an application manager can individually adjust the IT systems to suppress occurrence of monitoring spikes.

In the IT system satisfying (Third Request), however, an infrastructure manager and an application manager are separated from each other, and it is therefore difficult to individually adjust the IT systems unlike the conventional case.

To achieve an IT system that satisfies (First Request), (Second Request), and (Third Request), it is therefore essential to provide a technology of allocating an application and an application probe to a predetermined element resource in such a way as to suppress occurrence of a monitoring spike, and changing an element resource to which an application and an application probe are allocated, in a case where a monitoring spike larger than a predetermined size is detected.

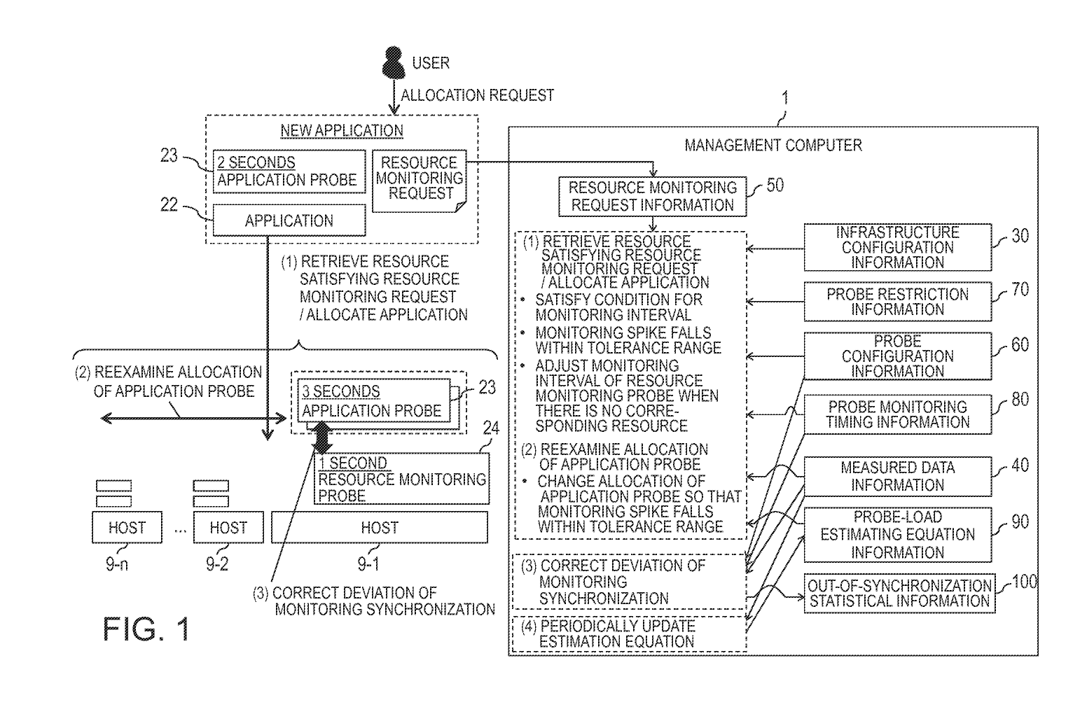

FIG. 1 is an explanatory diagram illustrating the outline of an embodiment of this invention. This embodiment is premised on an IT system having infrastructure resources including a plurality of hosts 9. The infrastructure resources may include other element resources such as a storage apparatus and a network switch.

A memory 3 of a management computer 1 that manages the IT system stores infrastructure configuration information 30, measured data information 40, resource monitoring request information 50, probe configuration information 60, probe restriction information 70, probe monitoring timing information 80, probe-load estimating equation information 90, and out-of-synchronization statistical information 100.

The infrastructure configuration information 30 stores configuration information of infrastructure resources managed by the management computer 1. The measured data information 40 stores performance values (measured data) of element resources as measurement targets to be measured by a resource monitoring probe 24 and an application probe 23 which operate on an element resource to be managed.

The resource monitoring request information 50 stores information on a resource monitoring request included in an allocation request input by a user when an application 22 and the application probe 23 are allocated to an element resource. Specifically, a monitoring target that needs to be monitored in synchronism with the application probe 23, and the monitoring interval of a probe that monitors the monitoring target are stored in the resource monitoring request information 50. Monitoring in synchronism with the application probe 23 represents that the monitoring timing of the resource monitoring probe 24 is synchronized with the monitoring timing of the application probe 23.

The monitoring interval represents a period for a probe to measure the performance value of a monitoring target, and the monitoring timing represents a point of time at which the probe actually measures the performance of the monitoring target. In the following description, the relation of the monitoring timing of one probe in synchronism with the monitoring timing of another probe is also referred to as a synchronous monitoring relation.

The probe configuration information 60 stores configuration information of probes, such as the monitoring intervals of the application probe 23 and the resource monitoring probe 24. The probe restriction information 70 stores restriction conditions, such as the minimum monitoring interval, for each of the types of the probes. The probe monitoring timing information 80 stores information on the resource monitoring probe 24 and the application probe 23 which are in the synchronous monitoring relation.

The probe-load estimating equation information 90 stores an estimating equation for estimating, for each probe type, the amount of resources which are consumed at the time of measuring the performance value. The out-of-synchronization statistical information 100 stores statistical information on the deviation of the monitoring timings of the resource monitoring probe 24 and the application probe 23 which are in the synchronous monitoring relation.

A process that is performed by the management computer 1 according to this embodiment is described now.

(1) When the user inputs a request to allocate a new application, the management computer 1 receives the input of the allocation request and a resource monitoring request. The management computer 1 retrieves an element resource that satisfies the resource monitoring request, and allocates a new application 22 and a new application probe 23 to the retrieved element resource.

The resource monitoring request includes information on the resource monitoring probe 24 that needs to perform monitoring in synchronism with the application probe 23, and the monitoring interval of the resource monitoring probe 24.

Specifically, first, the management computer 1 updates the resource monitoring request information 50 based on the resource monitoring request. The management computer 1 retrieves an element resource that satisfies the configuration of the requested element resource and the requested monitoring interval from among the infrastructure resources by referring to the infrastructure configuration information 30, the resource monitoring request information 50, and the probe configuration information 60.

Next, the management computer 1 estimates the size of a monitoring spike occurring, in a case where the application probe 23 is allocated to the retrieved element resource, by referring to the measured data information 40, the probe restriction information 70, the probe monitoring timing information 80, and the probe-load estimating equation information 90. Based on the result of estimation of the size of the monitoring spike, the management computer 1 allocates the application 22 and the application probe 23 to an element resource which minimizes the monitoring spike.

The monitoring spike represents the amount of computer resources that are consumed at the time of performing the process of monitoring the resource monitoring probe 24 and the application probe 23 that operate on a host 9. When the monitoring process is performed, a large amount of computer resources is consumed in a short period of time, in other words, the computer resources are consumed like a spike. A large monitoring spike, even if occurred temporarily, affects the smooth operations of other applications 22.

In addition, the management computer 1 adjusts the monitoring interval of the resource monitoring probe 24, as needed, by referring to the resource monitoring request information 50, the probe configuration information 60, and the probe restriction information 70.

In the example illustrated in FIG. 1, the management computer 1 retrieves, from a plurality of hosts 9, at least one host 9 on which the resource monitoring probe 24 that can perform monitoring in synchronism with the new application probe 23 having a monitoring interval of “two seconds” operates. According to this embodiment, the resource monitoring probe 24 whose monitoring timing is a divisor of “two seconds” is retrieved. Further, the management computer 1 allocates the new application 22 and the new application probe 23 to a host 9 which minimizes the estimated monitoring spike among the retrieved hosts 9.

(2) The management computer 1 periodically reexamines the allocation of the application probe 23 after the application 22 and the application probe 23 are allocated.

Specifically, the management computer 1 periodically checks the size of the monitoring spike of each element resource, and changes the element resource where the application 22 and the application probe 23 are allocated, in a case where the size of the monitoring spike is larger than the tolerance.

In the example illustrated in FIG. 1, the management computer 1 checks the size of the monitoring spike of each of the plurality of hosts 9. In a case where there is a host 9 whose size of the monitoring spike is larger than the tolerance, the management computer 1 migrates the application 22 and the application probe 23 that operate on this host 9 to another host 9.

(3) The management computer 1 monitors the deviation of the monitoring timings of the application probe 23 and the resource monitoring probe 24, and corrects the deviation of the monitoring timings, in a case where the deviation of the monitoring timings is larger than a predetermined threshold.

Specifically, the management computer 1 computes the deviation of the monitoring timings of the application probe 23 and the resource monitoring probe 24 which are in a synchronous monitoring relation by referring to the measured data information 40, the probe configuration information 60, and the probe monitoring timing information 80, and stores the computation result in the out-of-synchronization statistical information 100. The management computer 1 corrects the monitoring timing of the application probe 23, in a case where the computed deviation of the monitoring timings is larger than the predetermined threshold.

(4) The management computer 1 periodically reexamines the equation for estimating a monitoring spike. This improves the accuracy in estimating a monitoring spike.

Specifically, the management computer 1 refers to the measured data information 40 to obtain an equation for estimating the size of a monitoring spike. The management computer 1 updates the probe-load estimating equation information 90 based on the obtained estimation equation.

As described above, an element resource to which a new application 22 and a new application probe 23 are allocated is determined based on the estimation of the size of a monitoring spike in consideration of the synchronous relation between probes. Therefore, a plurality of probes whose monitoring timings are synchronized can obtain measured data useful in detailed examination of a performance failure, thereby suppressing occurrence of a monitoring spike whose size is larger than a predetermined size.

As a result, a manager can shorten the time needed to design allocation of probes, thus reducing the operational cost. In a cloud service in which an application manager and an infrastructure manager are isolated from each other, particularly, allocation of probes is automated so that cloud users can be provided with the service at a lower cost.

### First Embodiment

According to a first embodiment of this invention, the management computer 1 allocates a new application 22 and a new application probe 23 to an element resource that satisfies a resource monitoring request.

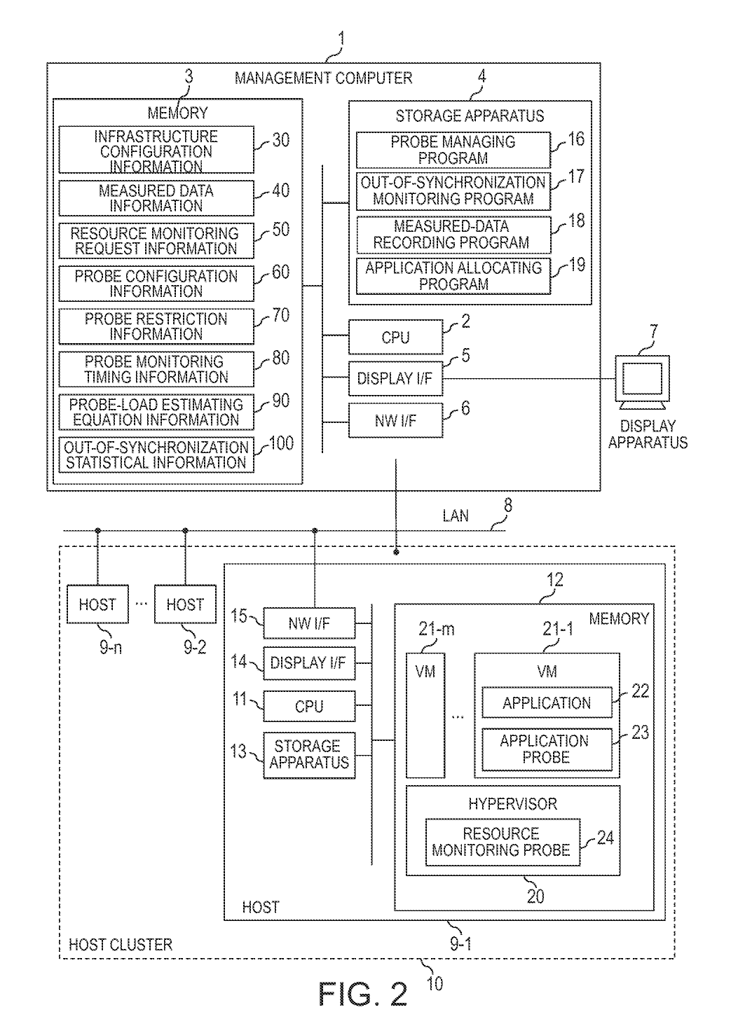

FIG. 2 is an explanatory diagram illustrating an example of the configuration of an IT system according to the first embodiment.

The IT system according to the first embodiment includes the management computer 1 and a plurality of hosts 9. According to the first embodiment, a host cluster 10 is constructed by the plurality of hosts 9. The management computer 1 is coupled to the individual hosts 9 via a LAN 8.

According to the first embodiment, the management computer 1 manages the plurality of hosts 9, a storage apparatus (not shown), a network switch (not shown), and the like included in the IT system as element resources constituting infrastructure resources. The management computer 1 also manages an application 22, a resource monitoring probe 24, and an application probe 23 which operate on a host 9. It should be noted that in place of a storage apparatus, a storage system including a plurality of storage apparatus may be managed as an element resource.

The management computer 1 includes a CPU 2, a memory 3, a storage apparatus 4, a display I/F 5, and a NW I/F 6.

The CPU 2 runs a program stored in the memory 3. This achieves the functions of the management computer 1.

The storage apparatus 4 is a storage medium that stores various kinds of information permanently, and may take the form of an HDD, SSD, or the like. The storage apparatus 4 stores a probe managing program 16, an out-of-synchronization monitoring program 17, a measured-data recording program 18, and an application allocating program 19. A program such as an OS (not shown) is also stored in the storage apparatus 4.

The CPU 2 maps each program on the memory 3, and runs the program mapped on the memory 3. In the following description, description of a process mainly in connection to a program indicates that the program is run by the CPU 2.

The probe managing program 16 manages allocation of the application 22 and the application probe 23 to an infrastructure resource. The out-of-synchronization monitoring program 17 manages the deviation of the monitoring timings of the application probe 23 and the resource monitoring probe 24 which are in a synchronous monitoring relation.

The measured-data recording program 18 records measured data which is transmitted from the resource monitoring probe 24 and the application probe 23. The application allocating program 19 allocates the application 22 and the application probe 23 to an infrastructure resource. The details of processes to be performed by the individual programs are given later.

The memory 3 stores a program to be run by the CPU 2, and information needed to execute the program. Infrastructure configuration information 30, measured data information 40, resource monitoring request information 50, probe configuration information 60, probe restriction information 70, probe monitoring timing information 80, probe-load estimating equation information 90, and out-of-synchronization statistical information 100 are stored in the memory 3. The details of each information are given later.

The display I/F 5 is an interface for coupling the management computer 1 to a display apparatus 7. The display apparatus 7 displays a screen to input various kinds of information and a screen to present a processing result to a manager who operates the management computer 1. The NW I/F 6 is an interface for coupling the management computer 1 to another apparatus over a network such as the LAN 8.

The host 9 is a computer on which the application 22 and the application probe 23 operate. According to this embodiment, the hosts 9 are managed as the host cluster 10 including a plurality of hosts 9. The host 9 includes a CPU 11, a memory 12, a storage apparatus 13, a display I/F 14, and a NW I/F.

The CPU 11 runs a program stored in the memory 12. This achieves the functions of the host 9.

The storage apparatus 13 is a storage medium that stores various kinds of information permanently, and may take the form of an HDD, SSD, or the like. The storage apparatus 4 stores a program such as an OS (not shown) and a hypervisor 20.

The memory 12 stores a program to be run by the CPU 11, and information needed to execute the program. A program that achieves the hypervisor 20 is stored in the memory 12. The CPU 11 runs this program to achieve the hypervisor 20.

The hypervisor 20 generates at least one VM 21 using the computer resources such as the CPU 11 and the memory 12 included in the host 9, and manages the at least one VM 21 generated. The hypervisor 20 in this embodiment includes the resource monitoring probe 24.

The resource monitoring probe 24 monitors the performances of the element resources, such as the host 9, the storage system (not shown) coupled to the host 9, and the hypervisor 20. The resource monitoring probe 24 transmits measured data to the measured-data recording program 18. The measured-data recording program 18 stores the measured data transmitted from the application probe 23 in the measured data information 40.

The resource monitoring probe 24 need not be included in the hypervisor 20. For example, the resource monitoring probe 24 may be included in middleware, or may operate on a monitoring apparatus (not shown) coupled to the host 9 over the LAN 8. In addition, the resource monitoring probe 24 may operate on the VM 21. In a case where the resource monitoring probe 24 operates on a monitoring apparatus (not shown), the resource monitoring probe 24 periodically obtains performance values from the hypervisor 20 and the like.

The VM 21 is a virtual machine that operates on the hypervisor 20. The application 22 and the application probe 23 operate on the VM 21. Although the application 22 and the application probe 23 operate on one VM 21 in the example illustrated in FIG. 2, the configuration is not limited to this example. In other words, the application 22 and the application probe 23 may operate on different VMs 21, respectively.

It is assumed in this embodiment that the hypervisor 20 has generated at least one VM 21 beforehand. At the time a VM 21 is generated, the application 22 and the application probe 23 have not been allocated to the VM 21 yet. It should be noted that the VM 21 need not be generated beforehand. The hypervisor 20 may generate the VM 21 at the time the application 22 and the application probe 23 are allocated, and the application 22 and the application probe 23 may be allocated to the generated VM 21.

The application 22 is a component of the IT system, and performs predetermined processing. For example, a database, a Web container, and the like are conceivable as the applications 22.

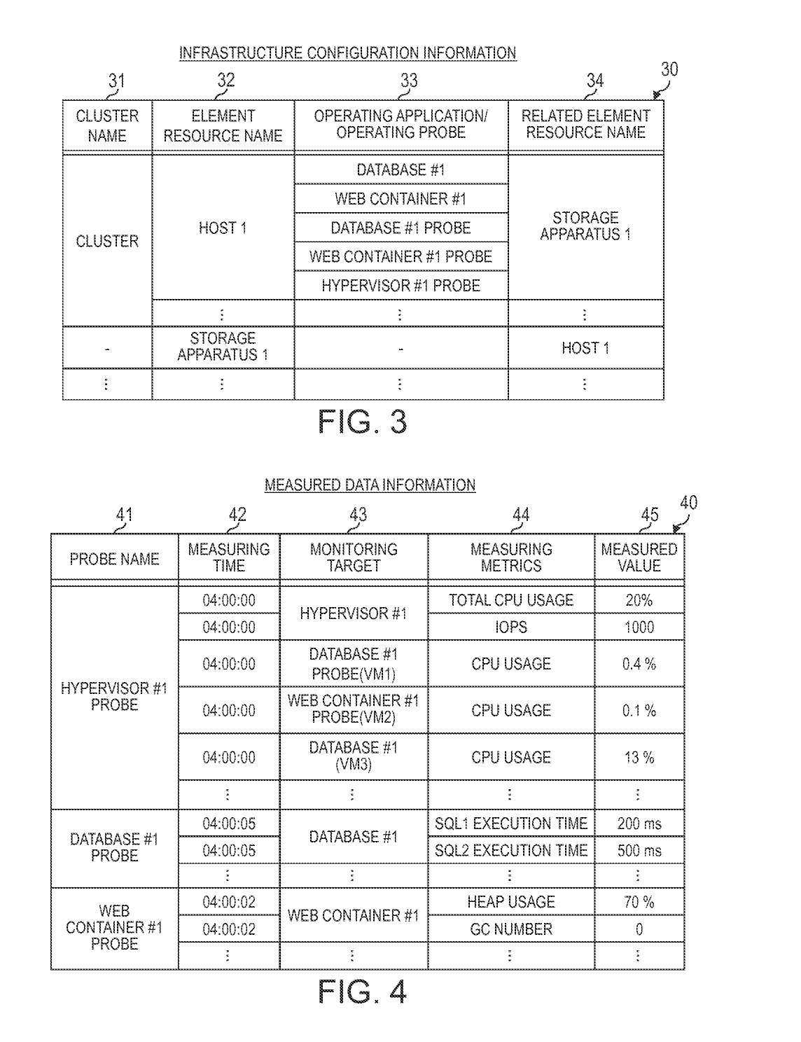

The application probe 23 measures the performance of the application 22, and, similarly to the resource monitoring probe 24, transmits measured data to the measured-data recording program 18. Accordingly, the measured performance value is stored in the measured data information 40. FIG. 3 is an explanatory diagram showing an example of the configuration of the infrastructure configuration information 30 according to the first embodiment.

The infrastructure configuration information 30 stores information on element resources to be managed and the relationship between element resources and information on the VM 21, the application 22 in operation, and the probes in operation. Specifically, the infrastructure configuration information 30 includes a cluster name 31, an element resource name 32, an operating application/operating probe 33, and a related element resource name 34.

The cluster name 31 is a name to identify the host cluster 10. The element resource name 32 is a name to identify an element resource constituting the infrastructure resources.

The operating application/operating probe 33 is a name to identify the application 22 and the application probe 23 that operate on an element resource corresponding to the element resource name 32.

The related element resource name 34 is a name to identify an element resource related to the element resource corresponding to the element resource name 32. In a case where a storage apparatus is coupled to the host 9, for example, the storage apparatus is an element resource related to the host 9.

The example shown in FIG. 3 shows that applications 22 having names of “database #1” and “Web container #1” operate on the host 9 whose element resource name 32 is “host 1”, and the host 9 is related to the storage apparatus whose related element resource name 34 is “storage apparatus 1”.

FIG. 4 is an explanatory diagram showing an example of the configuration of the measured data information 40 according to the first embodiment.

The measured data information 40 stores the performance value of a monitoring target that is measured by a probe, in other words, measured data. Specifically, the measured data information 40 includes a probe name 41, a measuring time 42, a monitoring target 43, a measuring metrics 44, and a measured value 45.

The probe name 41 is a name to identify a probe. The measuring time 42 is a time at which the performance value of the monitoring target is measured by the probe.

The monitoring target 43 is information for identifying the monitoring target of the probe. For the topmost entry shown in FIG. 3, for example, the monitoring target 43 indicates that monitoring targets of the hypervisor #1 probe are the hypervisor 20 itself, the VM 21 on which the database #1 probe operates, the VM 21 on which the Web container #1 probe operates, and the VM 21 on which the database #1 operates.

The measuring metrics 44 is information on a metrics to be measured in the monitoring target. The measured value 45 is the performance value actually measured by the probe.

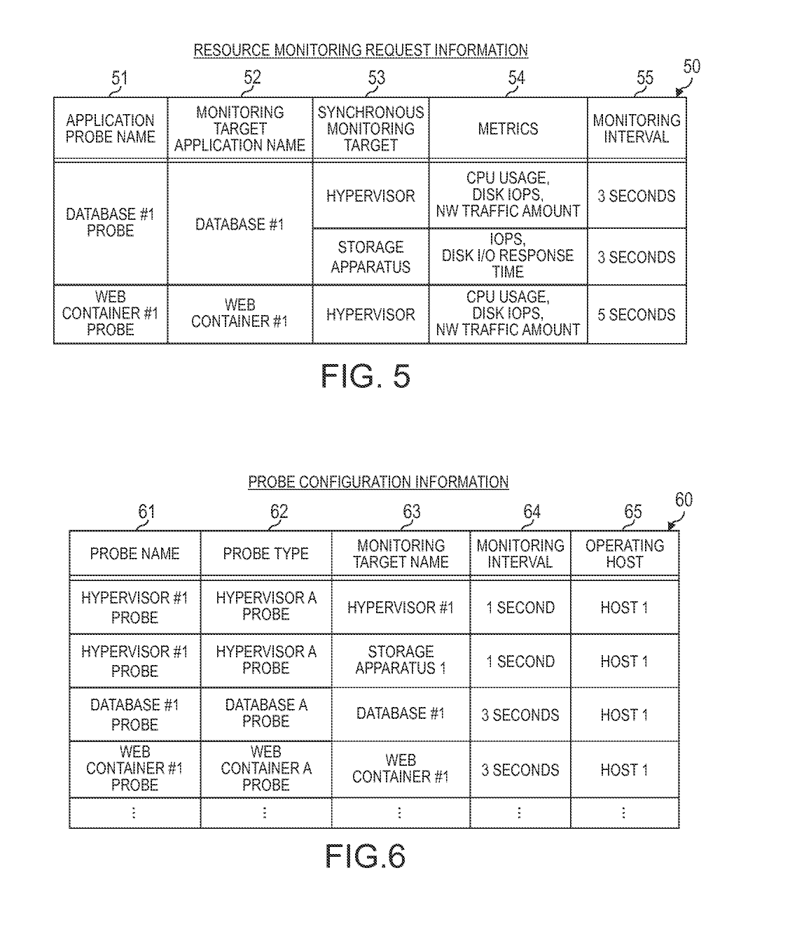

FIG. 5 is an explanatory diagram showing an example of the configuration of the resource monitoring request information 50 according to the first embodiment.

The resource monitoring request information 50 stores, for each application probe 23, information on the resource monitoring probe 24 that needs to perform monitoring in synchronism with the application probe 23. Specifically, the resource monitoring request information 50 includes an application probe name 51, a monitoring target application name 52, a synchronous monitoring target 53, a metrics 54, and a monitoring interval 55.

The application probe name 51 is the name of a new application probe 23 to be newly allocated in response to an allocation request. The monitoring target application name 52 is the name of a new application 22 that is monitored by the new application probe 23.

The synchronous monitoring target 53 is information representing the type of the monitoring target of the resource monitoring probe 24 that needs to perform monitoring in synchronism with the new application probe 23. In a case where the synchronous monitoring target 53 is “hypervisor”, it indicates that the host 9 on which the hypervisor 20 operates is an element resource of the monitoring target. In a case where the synchronous monitoring target 53 is “storage apparatus”, it indicates that the storage apparatus coupled to the host 9 on which the hypervisor 20 operates is an element resource of the monitoring target. Monitoring of the storage apparatus may be performed by the hypervisor probe that is the resource monitoring probe 24, or may be performed by another computer coupled over the LAN 8.

The metrics 54 is information on a metrics that is measured in the monitoring target of the resource monitoring probe 24. The monitoring interval 55 is the monitoring interval of the new application probe 23.

FIG. 6 is an explanatory diagram showing an example of the configuration of the probe configuration information 60 according to the first embodiment.

The probe configuration information 60 stores, for each probe currently operating, configuration information of probes such as the monitoring target and the operating host 9. Specifically, the probe configuration information 60 includes a probe name 61, a probe type 62, a monitoring target name 63, a monitoring interval 64, and an operating host 65.

The probe name 61 is a name to identify a probe. The probe type 62 is information representing the type of the probe. The monitoring target name 63 is the name of software to be monitored by the probe. In a case where the probe is the resource monitoring probe 24, the name of the hypervisor 20 is stored in the monitoring target name 63. In a case where the probe is the application probe 23, the name of the application 22 is stored in the monitoring target name 63.

The monitoring interval 64 is the monitoring interval of the probe. The operating host 65 is a name to identify the host 9 on which the probe operates.

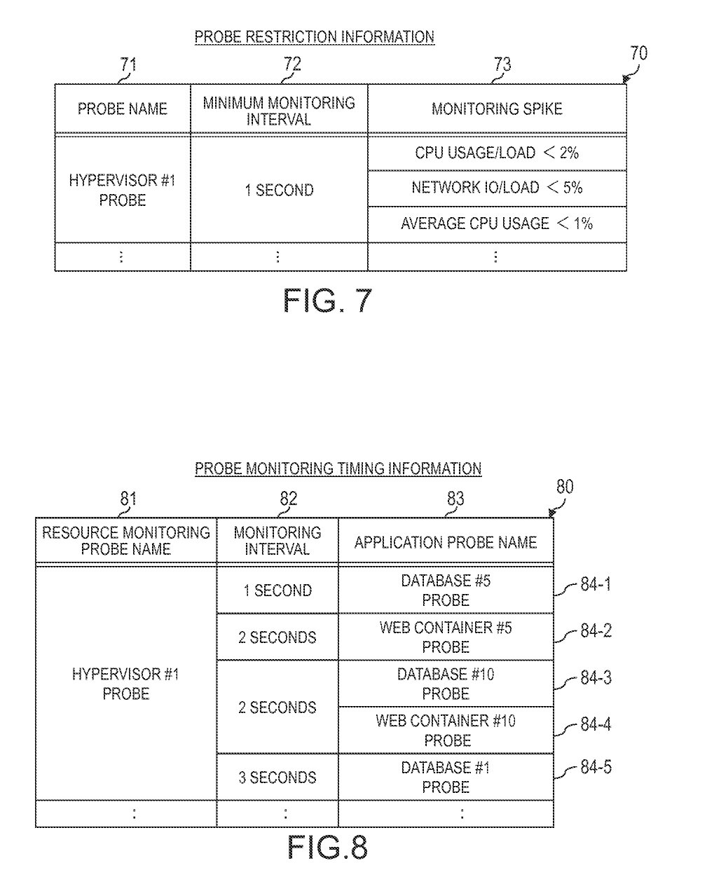

FIG. 7 is an explanatory diagram showing an example of the configuration of the probe restriction information 70 according to the first embodiment.

The probe restriction information 70 stores a restriction condition for each probe. Specifically, the probe restriction information 70 includes a probe name 71, a minimum monitoring interval 72, and a monitoring spike 73.

The probe name 71 is a name to identify a probe. The minimum monitoring interval 72 is the minimum monitoring interval that can be set for the probe.

The monitoring spike 73 is information representing the size of a tolerable monitoring spike for the resource monitoring probe 24 operating on the host 9. The monitoring spike 73 according to this embodiment stores an inequality expression indicating the tolerance range of the monitoring spike. The left-hand side of the inequality expression shows an equation representing the size of the monitoring spike, and the right-hand side of the inequality expression shows the tolerance of the size of the monitoring spike.

According to this embodiment, the management computer 1 manages the probe in such a way that the monitoring spike does not become larger than a predetermined upper limit. The value of the right-hand side of the inequality expression stored in the monitoring spike 73 corresponds to the “predetermined upper limit”.

The monitoring spike 73 in the entry corresponding to the resource monitoring probe 24 stores the tolerance of a monitoring spike that is the sum of a monitoring spike occurring in the resource monitoring probe 24 and a monitoring spike occurring in the application probe 23 having a synchronous monitoring relation with the resource monitoring probe 24.

FIG. 8 is an explanatory diagram showing an example of the configuration of the probe monitoring timing information 80 according to the first embodiment.

The probe monitoring timing information 80 stores, for each resource monitoring probe 24, an application probe 23 having a synchronous monitoring relation with the resource monitoring probe 24, and the monitoring interval of the application probe 23. Specifically, the probe monitoring timing information 80 includes a resource monitoring probe name 81, a monitoring interval 82, and an application probe name 83.

The resource monitoring probe name 81 is a name to identify the resource monitoring probe 24. The application probe name 83 is the name of the application probe 23 having a synchronous monitoring relation with the resource monitoring probe 24. The monitoring interval 82 is the monitoring interval of the application probe 23. The monitoring interval 82 corresponds also to the synchronization interval of the resource monitoring probe 24 and the application probe 23.

The example of FIG. 8 shows that a hypervisor #1 probe that is the resource monitoring probe 24 has a synchronous monitoring relation with five application probes 23 that operate on the hypervisor #1 to be monitored by the hypervisor #1 probe.

The monitoring interval 82 in an entry 84-1 is “one second”, and the application probe name 83 therein is “database #5 probe”. The entry 84-1 shows that the monitoring timing of the hypervisor #1 probe is synchronized with the monitoring timing of the database #5 probe every second.

The monitoring interval 82 in an entry 84-2 is “two seconds”, and the application probe name 83 therein is “Web container #5 probe”. The entry 84-2 shows that the monitoring timing of the hypervisor #1 probe is synchronized with the monitoring timing of the Web container #5 probe every two seconds.

The monitoring interval 82 in an entry 84-3 is “two seconds”, and the application probe name 83 therein is “database #10 probe”. The monitoring interval 82 in an entry 84-4 is “two seconds”, and the application probe name 83 therein is “Web container #10 probe”. The entry 84-3 shows that the hypervisor #1 probe is synchronized with the database #10 probe every two seconds, and the entry 84-4 shows that the hypervisor #1 probe is synchronized with the Web container #10 probe every two seconds. In addition, the database #10 probe and the Web container #10 probe are shown to have a synchronous monitoring relation with each other. On the other hand, the Web container #5 probe corresponding to the entry 84-2 having the same monitoring interval 82 is shown to have no synchronous monitoring relation with the database #10 probe and the Web container #10 probe. In other words, the monitoring timing of the Web container #5 probe is shifted from the monitoring timings of the database #10 probe and the Web container #10 probe by one second.

The monitoring interval 82 in an entry 84-5 is “three seconds”, and the application probe name 83 therein is “database #1 probe”. The entry 84-5 shows that the hypervisor #1 probe is synchronized with the database #1 probe every three seconds.

The monitoring interval of the database #1 probe is “three seconds”, while the monitoring intervals of the Web container #5 probe, the database #10 probe, and the Web container #10 probe are “two seconds”, and there is a synchronous monitoring relation with one another.

For example, when three seconds pass after synchronization of the monitoring timing of the database #1 probe with the monitoring timing of the Web container #5 probe, the monitoring timing of the database #1 probe is synchronized with the monitoring timings of the database #10 probe and the Web container #10 probe.

The probe monitoring timing information 80 is updated, in a case where the probe configuration is changed, such as allocation of a new application probe 23, or a change in the allocation of the application probe 23.

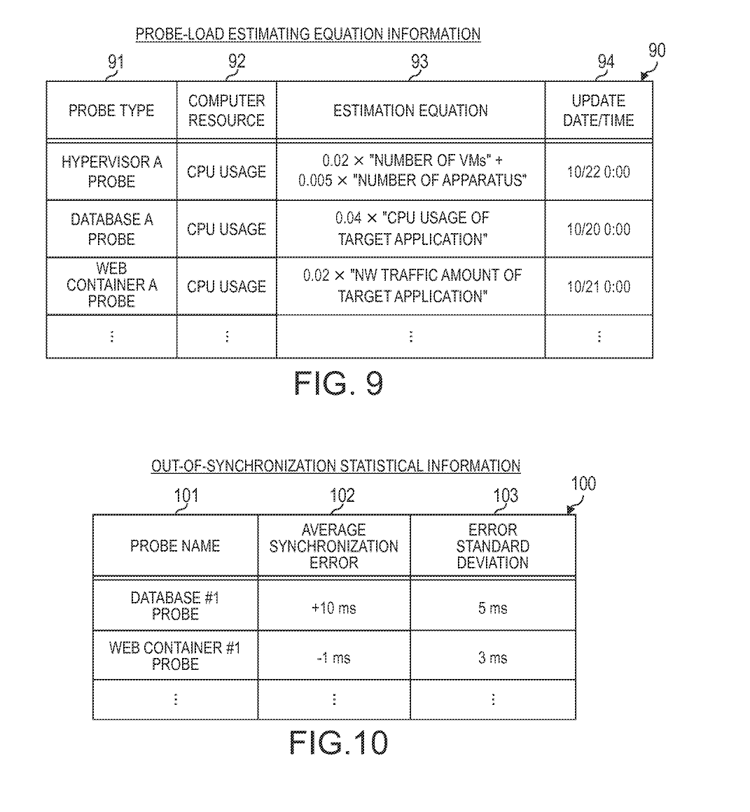

FIG. 9 is an explanatory diagram showing an example of the configuration of the probe-load estimating equation information 90 according to the first embodiment.

The probe-load estimating equation information 90 stores, for each probe type, an equation for estimating the consumption amount of computer resources per measurement of the probe. Specifically, the probe-load estimating equation information 90 includes a probe type 91, a computer resource 92, an estimation equation 93, and an update date/time 94.

The probe type 91 is information representing the type of a probe. The computer resource 92 is information representing the type of a computer resource that is consumed in an element resource on which the probe operates. The estimation equation 93 is used in a case of estimating the consumption amount of the computer resource that is consumed by the probe. The update date/time 94 is a date and time on which the estimation equation is updated.

The estimation equation may be generated by a probe developer, or may be generated using a statistical scheme based on actual measured data. A method of generating the estimation equation using a statistical scheme based on actual measured data is described in a sixth embodiment of this invention.

The management computer 1 can estimate the amount of the computer resource to be consumed by the probe by substituting adequate values for variables in the estimation equation, such as the “number of VMs” and “number of apparatus”.

FIG. 10 is an explanatory diagram showing an example of the configuration of the out-of-synchronization statistical information 100 according to the first embodiment.

The out-of-synchronization statistical information 100 stores, for each application probe, statistical information on the deviation between the monitoring timings of the resource monitoring probe 24 and the application probe 23 which are in the synchronous monitoring relation. Specifically, the out-of-synchronization statistical information 100 includes a probe name 101, an average synchronization error 102, and an error standard deviation 103.

The probe name 101 is the name of the application probe 23 that has a synchronous monitoring relation with the resource monitoring probe 24. The average synchronization error 102 is an average deviation at the synchronization timing (synchronized monitoring timing). The error standard deviation 103 is the standard deviation of the monitoring timings.

The out-of-synchronization statistical information 100 may include other statistical information such as the central value of deviation.

Next, a process that is performed by the management computer 1 is described.

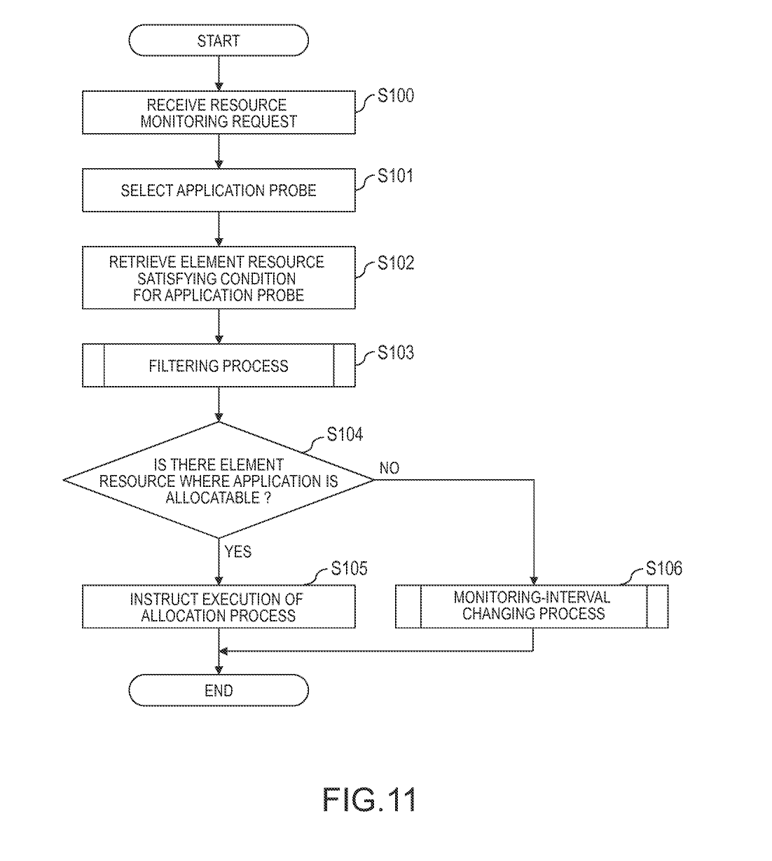

FIG. 11 is a flowchart illustrating the outline of a process of determining allocation of an application 22, which is performed by the management computer 1 according to the first embodiment.

In the process of determining allocation of an application 22, the probe managing program 16 retrieves an element resource that satisfies an infrastructure monitoring request from among element resources included in the infrastructure resources, and allocates the application 22 to the retrieved element resource.

In a case of receiving a resource monitoring request input together with an allocation request for a new application 22 from a user (Step S100), the management computer 1 calls the probe managing program 16 to start the process.

The probe managing program 16 updates the resource monitoring request information 50 based on the received resource monitoring request. The resource monitoring request may be data in the XML form.

The probe managing program 16 selects an application probe 23 to be processed from the resource monitoring request information 50 (Step S101). It is assumed that an application probe 23 is selected in order from the top entry of the resource monitoring request information 50.

The probe managing program 16 retrieves such a logical resource that the configuration of an element resource and the monitoring interval of the resource monitoring probe 24 satisfy conditions needed for the application probe 23 to be processed (Step S102). Specifically, the following process is performed.

The probe managing program 16 specifies the required configuration conditions of the element resource by referring to the synchronous monitoring target 53 in an entry corresponding to the selected application probe 23. For the topmost entry in FIG. 5, “hypervisor” and “storage apparatus” are stored in the synchronous monitoring target 53, showing that the host 9 to be coupled to the storage apparatus is requested.

The probe managing program 16 refers to the infrastructure configuration information 30 based on the specified configuration conditions of the element resource to retrieve an element resource satisfying the configuration conditions thereof. For the topmost entry in FIG. 5, the probe managing program 16 retrieves an entry where the name of the host 9 is stored in the element resource name 32 and the name of the storage apparatus is stored in the related element resource name 34.

The probe managing program 16 refers to the operating application/operating probe 33 in the retrieved entry to specify the name of the resource monitoring probe 24 that operates on the host 9. For the topmost entry in FIG. 5, the name of the resource monitoring probe 24 is specified as “hypervisor #1 probe”.

The probe managing program 16 refers to the probe configuration information 60 based on the specified name of the resource monitoring probe 24 to retrieve an entry whose probe name 61 matches the specified name of the resource monitoring probe 24. The probe managing program 16 obtains the monitoring interval of the resource monitoring probe 24 operating on the specified host 9 from the monitoring interval 64 in the retrieved entry.

The probe managing program 16 compares the value of the monitoring interval 55 in the resource monitoring request information 50 with the value of the monitoring interval 64 in the probe configuration information 60 to determine whether the specified resource monitoring probe 24 satisfies the monitoring interval condition requested by the resource monitoring request.

In a case where it is determined that the specified resource monitoring probe 24 satisfies the monitoring interval condition requested by the resource monitoring request, the probe managing program 16 adds the element resource satisfying the monitoring interval condition to a list of candidates. An entry having a combination of a resource name and a resource monitoring probe name is registered in the candidate list.

According to this embodiment, it is determined whether the monitoring interval of the resource monitoring probe 24 is a divisor of the value of the monitoring interval 55 as the monitoring interval condition. In a case where the monitoring interval of the resource monitoring probe 24 is a divisor of the value of the monitoring interval 55, it is determined that the monitoring interval condition is satisfied.

The monitoring interval for the synchronous monitoring target 53 that is “hypervisor” is “three seconds” for the topmost entry in FIG. 5, whereas the monitoring interval 64 for the entry whose probe name 61 is “hypervisor #1 probe” and whose monitoring target name 63 is “hypervisor #1” is “one second”. In addition, the monitoring interval for the synchronous monitoring target 53 that is “storage apparatus” is “three seconds”, whereas the monitoring interval 64 for the entry whose probe name 61 is “hypervisor #1 probe” and whose monitoring target name 63 is “storage apparatus 1” is “one second”. The management computer 1 therefore determines that the hypervisor #1 probe satisfies the monitoring interval condition.

It should be noted that the monitoring interval condition is not limited to the above. For example, it may be determined whether the monitoring interval of the resource monitoring probe 24 is smaller than the value of the monitoring interval 55. In a case where the monitoring interval of the resource monitoring probe 24 is smaller than the value of the monitoring interval 55, for example, it is determined that the monitoring interval condition is satisfied.

The above is the description of the process of Step S102.

Next, the probe managing program 16 performs a filtering process on the element resource retrieved in Step S102 (Step S103).

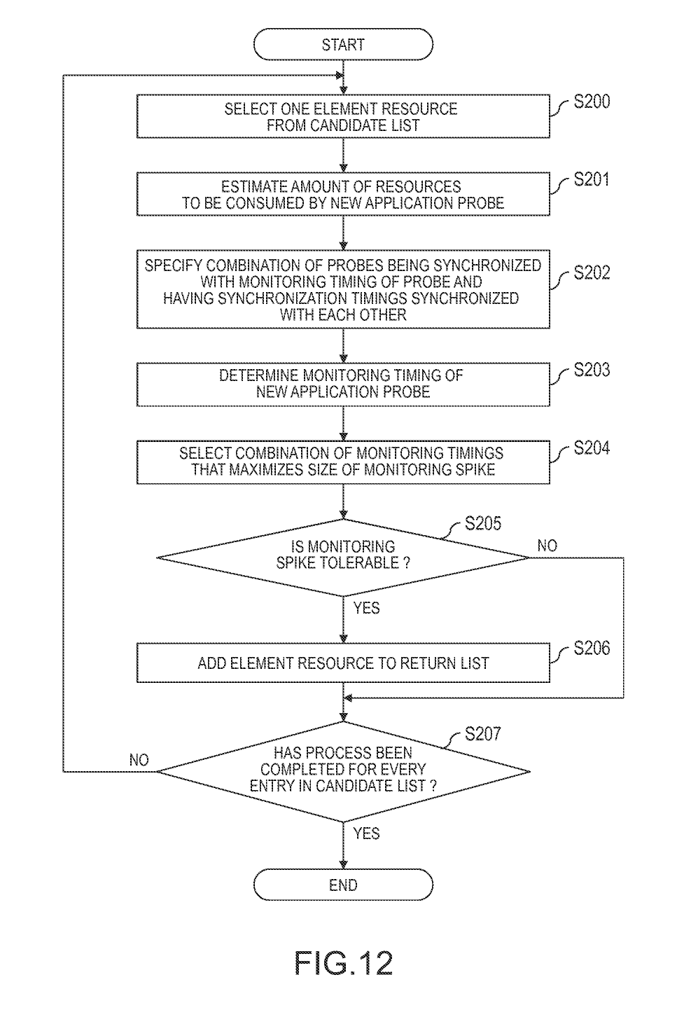

In the filtering process, the probe managing program 16 determines whether the size of a monitoring spike, in a case where the new application 22 and the new application probe 23 are allocated to an element resource to be registered in the candidate list falls within the tolerance range. An element resource whose monitoring spike has a size not falling within the tolerance range is removed from the candidate list. The details of the filtering process are given later referring to FIG. 12.

The probe managing program 16 determines whether there is an element resource to which the new application 22 and the new application probe 23 are allocatable among the element resources included in a return list which is the result of the process of Step S103 (Step S104). Specifically, the probe managing program 16 determines whether at least one entry is included in the candidate list output as the result of the process of Step S103. In the following description, an element resource to which a new application 22 and a new application probe 23 are allocatable is also referred to as an allocation candidate resource.

In a case where it is determined that an allocation candidate resource is present, the probe managing program 16 transmits an instruction to perform an allocation process together with the return list to the application allocating program 19 (Step S105), after which the process is terminated.

In a case of receiving the instruction to perform the allocation process, the application allocating program 19 analyzes the free resource amounts of element resources included in the candidate list, and allocates the application 22 and the application probe 23 to an element resource that has the largest free resource amount. The above-mentioned allocation process is a known technology called Intelligent Placement. Various allocation methods have been proposed in addition to the above-mentioned process. The allocation process is not limited to its contents, and any process may be used.

The probe managing program 16 adds information on the new application 22 and the new application probe 23 to the infrastructure configuration information 30 and the probe configuration information 60 after the allocation process is completed.

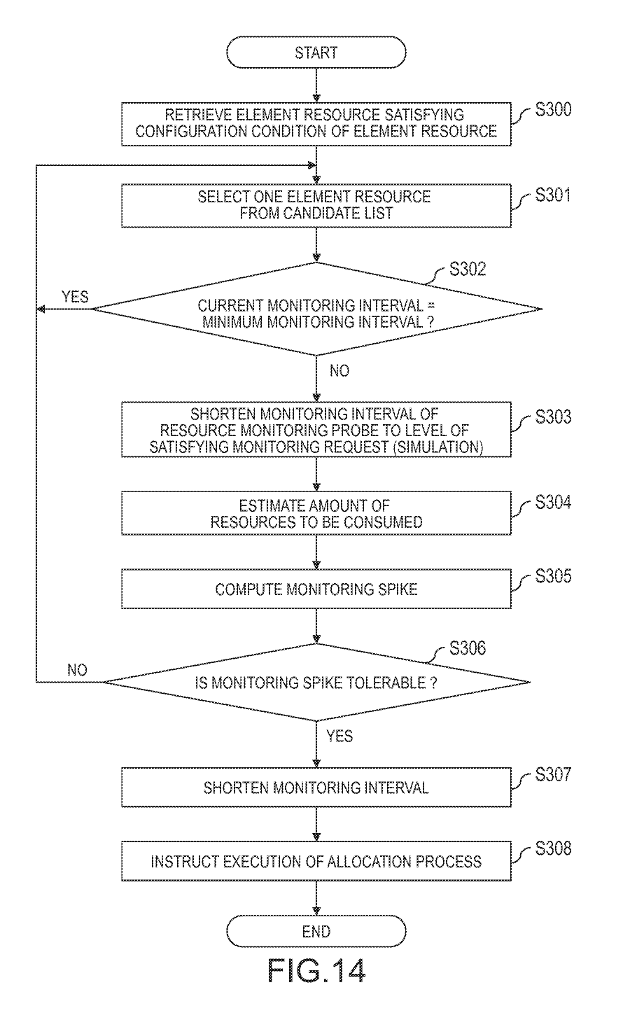

In a case where it is determined that no allocation candidate resource is present, the probe managing program 16 performs a monitoring-interval changing process to change the monitoring interval of the resource monitoring probe 24 in such a way that the monitoring interval matches the resource monitoring request (Step S106), after which the process is terminated. The details of the monitoring-interval changing process are given later referring to FIG. 14.

FIG. 12 is a flowchart illustrating an example of the filtering process according to the first embodiment.

The probe managing program 16 selects one element resource to be processed from the candidate list (Step S200). At this time, the probe managing program 16 deletes an entry corresponding to the selected element resource from the candidate list.

The probe managing program 16 refers to the probe configuration information 60 and the probe-load estimating equation information 90 to estimate the amount of resources to be consumed by the application probe 23, in other words, a monitoring spike (Step S201). Specifically, the following process is performed.

The probe managing program 16 refers to the probe configuration information 60 to retrieve an entry whose probe name 61 matches the application probe name 51 of the entry selected in Step S101.

The probe managing program 16 refers to the probe-load estimating equation information 90 to retrieve an entry whose probe type 91 matches the probe type 62 of the retrieved entry. Further, the probe managing program 16 obtains an estimation equation from the estimation equation 93 in the retrieved entry.

The probe managing program 16 computes the amount of resources to be consumed by the application probe 23 by substituting predetermined values for variables in the obtained estimation equation.

In a case where the amount of resources to be consumed by a new application 22 is a variable in the estimation equation, the amount of resources to be consumed by the new application 22 is expected to be unknown at the time of allocating the new application 22. In this case, the probe managing program 16 computes the amount of resources to be consumed by the application probe 23 by using the maximum value of the amount of resources to be consumed by the application 22.

In a case where the CPU usage of a target application 22 is a variable in an estimation equation 93 and is unknown, for example, the probe managing program 16 computes the amount of resources to be consumed by the application probe 23 by using the maximum CPU usage of the VM 21 on which the target application 22 operates.

The above is the description of the process of Step S201.

Next, the probe managing program 16 refers to the probe monitoring timing information 80 to specify a combination of probes that have a synchronous monitoring relation with the resource monitoring probe 24, and have a synchronous monitoring relation with each other (Step S202). Specifically, the following process is performed.

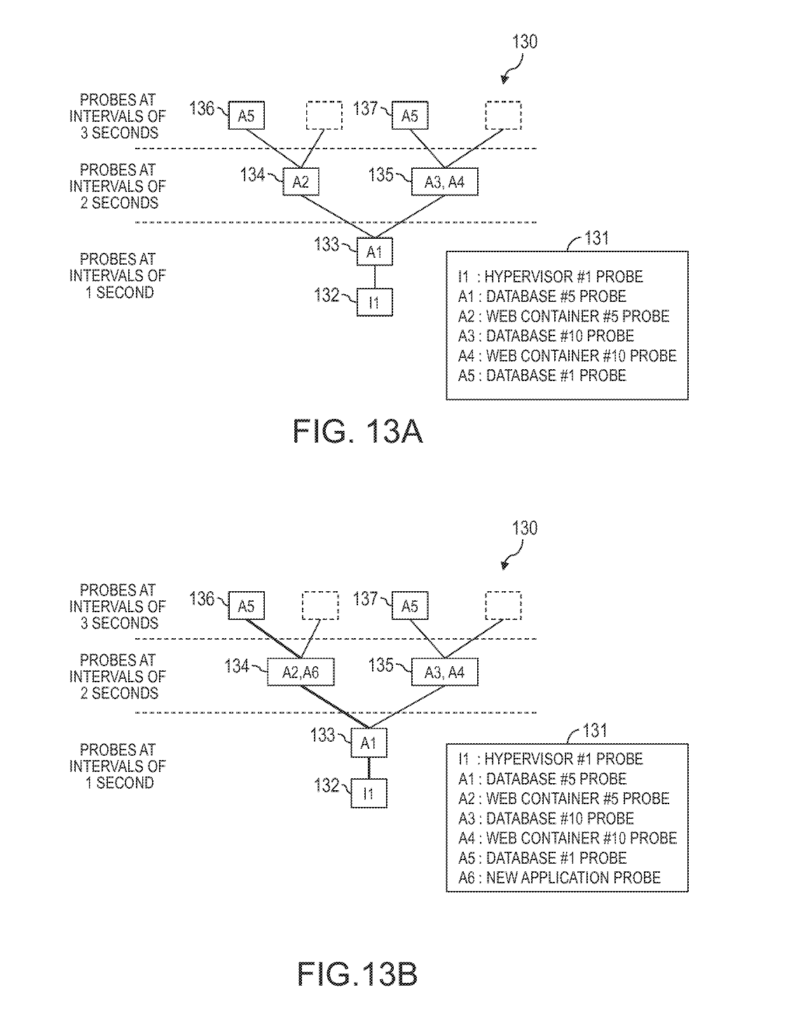

The probe managing program 16 refers to the probe monitoring timing information 80 to generate a monitoring timing tree 130 as illustrated in FIG. 13A.

FIGS. 13A and 13B are explanatory diagrams illustrating an example of the monitoring timing tree 130 according to the first embodiment.

The monitoring timing tree 130 shows combinations of probes that take measurements simultaneously at a certain monitoring timing, in other words, probes having a synchronous monitoring relation. The monitoring timing tree 130 illustrated in FIG. 13A is generated based on the probe monitoring timing information 80 shown in FIG. 8.

Rectangles “I1”, “A1”, etc. in the diagram correspond to probes as illustrated in a description 131 in the diagram, and are also referred to as nodes in the following description. The probes corresponding to the nodes are described using symbols in the description 131.

A method of generating the monitoring timing tree 130 is described now.

The probe managing program 16 regards the hypervisor #1 probe which is the resource monitoring probe 24 as a root node 132 in the monitoring timing tree 130. This is because all the application probes 23 that operate on the host 9 have a synchronous monitoring relation with the resource monitoring probe 24.

Next, the probe managing program 16 obtained application probes 23 having a synchronous monitoring relation with the hypervisor #1 probe in the ascending order of the value of the monitoring interval 82, and generates the monitoring timing tree 130 in a direction from the root node to leaf nodes.

In the example shown in FIG. 8, the probe managing program 16 places a node 133 of the database #5 probe whose monitoring interval 82 is “one second” above a node 132 of the root node, and connects both nodes by a branch.

Next, the probe managing program 16 places the Web container #5 probe whose monitoring interval 82 is “two seconds” as a child node 134 of the node 133, and places the database #10 probe and the Web container #10 probe as a child node 135 of the node 133. In other words, probes that have the same monitoring interval but do not have a synchronous monitoring relation are placed as separate nodes. The probe managing program 16 connects the node 133 to the node 134 by a branch, and connects the node 133 to the node 135 by a branch.

Finally, the probe managing program 16 places the database #1 probe whose monitoring interval 82 is “three seconds” as a child node 136 of the node 134 and as a child node 137 of the node 135. This is because the database #1 probe has a synchronous monitoring relation with the Web container #5 probe, and also has a synchronous monitoring relation with the database #10 probe and the Web container #10 probe.

The probe managing program 16 connects the node 134 to the node 136 by a branch, and connects the node 135 to the node 137 by a branch.

In FIG. 13A, dotted-line rectangles each representing that there is no corresponding application probe 23 are placed besides the node 136 and the node 137 to show all combinations of probes having a synchronous monitoring relation.

It is apparent from the monitoring timing tree 130 generated in the above-mentioned process that there are four paths in the direction from the root node to the leaf nodes. The four paths are (node 132, node 133, node 134, node 136), (node 132, node 133, node 134), (node 132, node 133, node 135, node 137), and (node 132, node 133, node 135). The four paths are all the combinations of the probes that take measurements at the same monitoring timing.

It should be noted that the method of specifying a combination of probes whose monitoring timings are synchronized is not limited to the one using the monitoring timing tree 130, and any method may be used as long as the four paths can be specified as described above.

The description returns to the description of FIG. 12.

Next, the probe managing program 16 determines the monitoring timing of a new application probe 23 based on the probe combination (Step S203). Specifically, the following process is performed. In the following description, it is assumed that the monitoring interval of the new application probe 23 is two seconds.

The probe managing program 16 refers to the monitoring timing tree 130 to compare the sizes of the monitoring spikes of the node 134 and the node 135 having a monitoring interval of two seconds with each other.

The size of the monitoring spike of an application probe 23 corresponding to each node is obtained based on the measured data information 40. To obtain the size of the monitoring spike of the database #1 probe, for example, the probe managing program 16 retrieves an entry whose probe name 41 is “database #1 probe” from the measured data information 40, and obtains the maximum value of the measured value 45 for each measuring metrics 44 in the retrieved entry. A statistical value such as the average value or central value of the monitoring spike, instead of the maximum value, may be used as the size of the monitoring spike.

The probe managing program 16 determines a node having a small monitoring spike in the result of comparing the sizes of monitoring spikes as a node to which the new application probe 23 is to be added. Accordingly, a probe having a synchronous monitoring relation with the new application probe 23 is determined. That is, the monitoring timing of the new application probe 23 is determined.

In a case where there are a plurality of types of monitoring spikes, the probe managing program 16 computes all the corresponding monitoring spikes. In the example shown in FIG. 3, for example, three types of monitoring spikes are computed. In this case, the probe managing program 16 may pay attention to one type of monitoring spike, and may determine the monitoring timing of a new application probe 23 based on only the size of this monitoring spike. Further, the probe managing program 16 may determine the monitoring timing of the new application probe 23 based on the sum of the three types of monitoring spikes.

FIG. 13B illustrates the monitoring timing tree 130 after the new application probe 23 is added.

The above is the description of the process of Step S203.

Then, the probe managing program 16 specifies a combination of the monitoring timings that maximizes the size of a monitoring spike (Step S204).

Specifically, the probe managing program 16 computes the size of a monitoring spike for each path in the monitoring timing tree 130, and specifies a path having a largest monitoring spike, in other words, the combination of the monitoring timings that maximizes the size of a monitoring spike.

It is assumed that the size of a monitoring spike on each path is computed by summing the sizes of monitoring spikes of the individual nodes on the path. In the following description, a path having a largest monitoring spike is referred to as a critical path.

Next, based on the size of the monitoring spike of the selected combination of monitoring timings, the probe managing program 16 determines whether the monitoring spike is tolerable (Step S205). Specifically, the following process is performed.

The probe managing program 16 refers to the probe restriction information 70 to obtain a monitoring spike 73 from an entry corresponding to the type of the resource monitoring probe 24. The probe managing program 16 determines whether the size of the monitoring spike satisfies an inequality expression stored in the monitoring spike 73, based on the size of the monitoring spike on the critical path. That is, it is determined whether the size of the monitoring spike on the critical path is smaller than the tolerance.

In a case where it is determined that the size of the monitoring spike does not satisfy the inequality expression stored in the monitoring spike 73, the probe managing program 16 determines that the monitoring spike is not tolerable.

In a case where a plurality of types of monitoring spikes are present, the probe managing program 16 determines for each type of monitoring spike whether the size of the monitoring spike on the critical path is smaller than the tolerance. In a case where there is at least one type of monitoring spike whose size is larger than the tolerance, the probe managing program 16 determines that the monitoring spike is not tolerable.

The above is the description of the process of Step S205.

In a case where it is determined that the monitoring spike is not tolerable, the probe managing program 16 proceeds to Step S207.

In a case where it is determined that the monitoring spike is tolerable, the probe managing program 16 adds the element resource selected in Step S200 to the return list as an adequate element resource (Step S206), and then proceeds to Step S207.

The return list includes an entry having a combination of the resource name and the size of the monitoring spike on the critical path computed in Step S205.

Specifically, in a case where there is no return list, the probe managing program 16 generates a return list, and adds the entry to the return list. In a case where there is a return list, the probe managing program 16 adds the entry to the return list. Further, the probe managing program 16 sorts the entries in the return list based on the size of the monitoring spike on the critical path.

The probe managing program 16 determines whether the process is completed for every entry in the candidate list (Step S207). Specifically, the probe managing program 16 determines whether there is an entry in the candidate list.

In a case where it is determined that the process is not completed for every entry in the candidate list, the probe managing program 16 returns to Step S200 to perform similar processing.

In a case where it is determined that the process is completed for every entry in the candidate list, the probe managing program 16 terminates the process.

An element resource to be added to the return list may be determined based on the number of probes included in a path.

In this case, instead of performing Step S204, the probe managing program 16 computes the number of probes included in each path, and determines the path that has a largest number of probes as a critical path. Further, instead of performing Step S205, the probe managing program 16 determines whether the number of probes included in the critical path is larger than a predetermined threshold. In a case where the number of probes included in the critical path is larger than the predetermined threshold, the probe managing program 16 determines that the monitoring spike is not tolerable.

FIG. 14 is a flowchart illustrating a monitoring-interval changing process according to the first embodiment.

The probe managing program 16 retrieves such a resource that the configuration of the element resource satisfies the configuration condition of the element resource required of the application probe 23 to be processed (Step S300). The process of Step S300 is equivalent to a retrieval process to which the monitoring interval condition is applied in the process of Step S102. The probe managing program 16 generates a candidate list from information on the retrieved element resource.

The probe managing program 16 selects one entry corresponding to the element resource to be processed from the candidate list (Step S301). At this time, the probe managing program 16 deletes the selected entry from the candidate list. In the following description, the selected element resource is referred to as an element resource A.

According to this embodiment, the probe managing program 16 selects element resources from the candidate list in the descending order of the amount of free resources.

The probe managing program 16 determines whether the current monitoring interval of the resource monitoring probe 24 that monitors the element resource A is the same as the minimum monitoring period (Step S302). Specifically, the following process is performed.

Based on the resource monitoring probe name in an entry in the candidate list that corresponds to the element resource A, the probe managing program 16 refers to the probe configuration information 60 to specify an entry corresponding to the resource monitoring probe 24 that monitors the element resource A. In the following description, the specified resource monitoring probe 24 is referred to as a resource monitoring probe A.

Based on the resource monitoring probe name in an entry in the candidate list that corresponds to the element resource A, the probe managing program 16 also refers to the probe restriction information 70 to specify an entry corresponding to the resource monitoring probe A.

The probe managing program 16 compares the value of the monitoring interval 64 of the entry specified from the probe configuration information 60 with the value of the minimum monitoring interval 72 of the entry specified from the probe restriction information 70. The probe managing program 16 determines whether the value of the monitoring interval 64 is the same as the value of the minimum monitoring interval 72.

In a case where it is determined that the monitoring interval of the resource monitoring probe A is the same as the minimum monitoring interval, the probe managing program 16 returns to Step S301 to perform similar processing. This is because the current monitoring period of the resource monitoring probe A cannot be made shorter.

In a case where it is determined that the monitoring interval of the resource monitoring probe A is larger than the minimum monitoring interval, the probe managing program 16 simulates shortening of the monitoring interval of the resource monitoring probe A that satisfies the monitoring interval condition (Step S303).

Specifically, the probe managing program 16 simulates shortening of the monitoring interval of the resource monitoring probe A to the monitoring interval requested in the resource monitoring request, in other words, the monitoring interval 55. It should be noted however that the shortened monitoring interval is equal to or greater than the value of the minimum monitoring interval 72.

The probe managing program 16 estimates the amount of resources to be consumed by the resource monitoring probe A whose monitoring interval is shortened, in other words, a monitoring spike (Step S304).

The amount of resources to be consumed by the resource monitoring probe A in each measurement is not changed. However, the amount of resources to be consumed in unit time increases by the reduction in the monitoring interval of the resource monitoring probe A. In a case where the monitoring interval of the resource monitoring probe A is shortened to one second from five seconds, for example, the amount of resources to be consumed in unit time increases by fivefold.

The probe managing program 16 computes a monitoring spike on the critical path based on the estimated amount of resources (Step S305). Because the method of computing a monitoring spike on the critical path is identical to the method described in connection to Steps S202 to S204, its description is omitted.

The probe managing program 16 determines whether the monitoring spike is tolerable based on the size of the monitoring spike on the critical path (Step S306). Here, it is determined whether the total amount of resources to be consumed in unit time that increases by the shortening of the monitoring interval of the resource monitoring probe A falls within a tolerance range. The description of the process of Step S305 is omitted because the process is similar to the process of Step S205.

In a case where it is determined that the monitoring spike is not tolerable, the probe managing program 16 returns to Step S301 to perform similar processing.

In a case where it is determined that the monitoring spike is tolerable, the probe managing program 16 actually shortens the monitoring interval of the resource monitoring probe A, and updates the monitoring interval 64 in the probe configuration information 60 (Step S307).

The probe managing program 16 transmits an instruction to perform an allocation process together with the name of the element resource A to the application allocating program 19 (Step S308), after which the process is terminated.

In a case of receiving the instruction to perform the allocation process, the application allocating program 19 allocates the new application 22 and the new application probe 23 to the element resource A.

After completion of the allocation process, the probe managing program 16 adds information on the new application 22 and the new application probe 23 to the infrastructure configuration information 30 and the probe configuration information 60.

According to the first embodiment, based on the resource monitoring request, the management computer 1 can allocate the new application 22 and the new application probe 23 to the element resource which satisfies the configuration condition and the monitoring interval condition and whose monitoring spike falls within a tolerance range.

Accordingly, it is possible to achieve fine-grained monitoring and synchronized monitoring, and to allocate the application 22 and the application probe 23 in such a way that monitoring-originated load becomes smaller.

Therefore, resources that satisfy a user's request can be allocated, and measured data useful in examination of a failure can be obtained.

### Second Embodiment

According to a second embodiment of this invention, after an application 22 is allocated to an element resource, the management computer 1 periodically checks the size of a monitoring spike in each element resource, and the element resource to which the application 22 and the application probe 23 are to be allocated is changed so that the size of the monitoring spike falls within the tolerance range, in a case where there is a monitoring spike larger than the tolerance range.

The following describes the second embodiment focusing on the differences from the first embodiment.

Because the configuration of an IT system, the configuration of the management computer 1, and the configuration of the host 9 in the second embodiment are identical to those of the first embodiment, their descriptions are omitted. In addition, because the individual pieces of information held in the management computer 1 are identical to those of the first embodiment, their descriptions are likewise omitted.

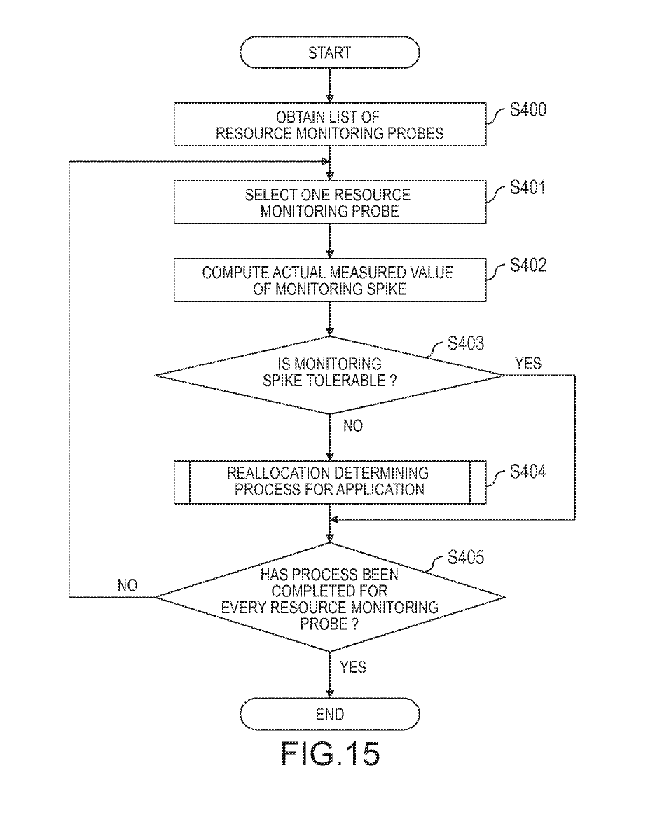

FIG. 15 is a flowchart illustrating a monitoring-spike checking process that is performed by the management computer 1 according to the second embodiment.

The probe managing program 16 refers to the probe monitoring timing information 80 to obtain a list of resource monitoring probes 24 in operation (Step S400).

The probe managing program 16 selects one resource monitoring probe 24 to be processed from the list of resource monitoring probes 24 (Step S401). At this time, the probe managing program 16 deletes an entry corresponding to the selected resource monitoring probe 24 from the list of resource monitoring probes 24. In the following description, the selected resource monitoring probe 24 is referred to as the resource monitoring probe A, and the element resource to be monitored by the resource monitoring probe A is referred to as the element resource A.

The probe managing program 16 computes the actual measured values of monitoring spikes generated by a plurality of probes operating on the element resource A (Step S402). Specifically, the following process is performed.

The probe managing program 16 refers to the probe monitoring timing information 80 based on the name of the resource monitoring probe A to specify an application probe 23 having a synchronous monitoring relation with the resource monitoring probe A. The probe managing program 16 refers to the measured data information 40 to obtain the amount of resources to be consumed by each probe based on the measured value 45 in the entry corresponding to the resource monitoring probe A and the specified application probe 23.

The probe managing program 16 generates a monitoring timing tree 130, and computes the size of a monitoring spike for each path in the monitoring timing tree 130. Because the method of generating the monitoring timing tree 130, and the method of computing the size of a monitoring spike for each path in the monitoring timing tree 130 are identical to those used in Steps S202 and S204, their detailed descriptions are omitted.

The above is the description of the process of Step S402.

Next, the probe managing program 16 determines whether the monitoring spike is tolerable based on the size of the monitoring spike on the critical path (Step S403). The description of the process of Step S403 is omitted because the process is similar to the process of Step S205.

In a case where it is determined that the monitoring spike is tolerable, the probe managing program 16 proceeds to Step S405.

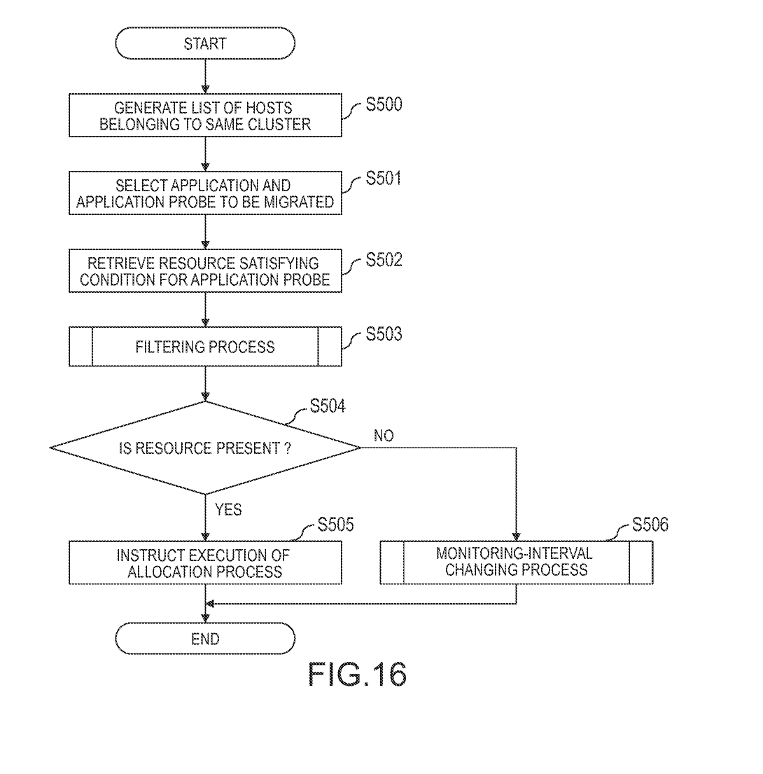

In a case where it is determined that the monitoring spike is not tolerable, the probe managing program 16 performs a reallocation determining process for the application 22 in such a way that the monitoring spike falls within the tolerance range (Step S404), and then proceeds to Step S405. The details of the reallocation determining process for the application 22 are given later referring to FIG. 16.

The probe managing program 16 determines whether the process is completed for every resource monitoring probe 24 (Step S405). Specifically, the probe managing program 16 determines whether there is an entry in the list of the resource monitoring probes 24.

In a case where it is determined that the process is not completed for every resource monitoring probe 24, the probe managing program 16 returns to Step S401 to perform similar processing.

In a case where it is determined that the process is completed for every resource monitoring probe 24, the probe managing program 16 terminates the process.

FIG. 16 is a flowchart illustrating the reallocation determining process for the application 22 that is performed by the management computer 1 according to the second embodiment.

The probe managing program 16 refers to the infrastructure configuration information 30 to generate a list of element resources (hosts 9) belonging to the same cluster as the element resource (host 9) on which the resource monitoring probe A operates (Step S500).

Specifically, the probe managing program 16 refers to the operating application/operating probe 33 in the infrastructure configuration information 30 based on the name of the resource monitoring probe A to specify an entry corresponding to the host 9 on which the resource monitoring probe A operates. The probe managing program 16 generates the list of hosts 9 belonging to the same cluster based on the cluster name 31 of the specified entry. In the reallocation determining process, a host 9 included in this list becomes a resource to which the application 22 and the application probe 23 are migrated.

The probe managing program 16 refers to the infrastructure configuration information 30 to select the application 22 and the application probe 23 that are to be migrated (Step S501). In the following description, the selected application 22 is referred to as the application A, and the selected application probe 23 is referred to as the application probe A.

With regard to the algorithm for selecting the application A and the application probe A, there are many known algorithms as the method of optimizing allocation of a virtual machine. For example, a possible method is to select the application A and the application probe A based on the amount of resources.

The processing from Step S502 to Step S506 is the same as the processing from Step S102 to Step S106. However, this embodiment differs in that element resources to which the application A and the application probe A are to be allocated are retrieved from hosts 9 belonging to the same cluster.

### Third Embodiment

There is a case where after allocation of an application 22, the monitoring interval of an application probe 23 set by the infrastructure resource monitoring request needs to be changed. For example, taking a measure to detect occurrence of a failure early is such a case. To detect a failure early after occurrence thereof, or to quickly examine the failure, the monitoring interval of the application probe 23 may be shortened.

According to a third embodiment of this invention, the probe managing program 16 adjusts the probe environment in accordance with a change in the monitoring interval of the application probe 23.

The following describes the third embodiment focusing on the differences from the first embodiment.

Because the configuration of an IT system, the configuration of the management computer 1, and the configuration of the host 9 in the third embodiment are identical to those of the first embodiment, their descriptions are omitted. In addition, because the individual pieces of information held in the management computer 1 are identical to those of the first embodiment, their descriptions are likewise omitted.

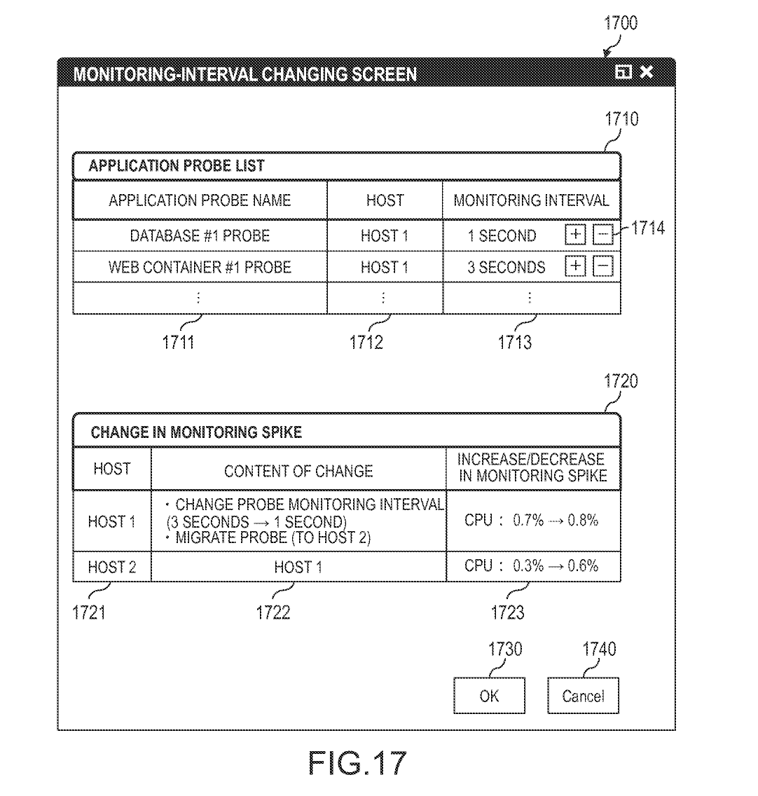

FIG. 17 is an explanatory diagram illustrating an example of a monitoring-interval changing screen 1700 according to the third embodiment.

The monitoring-interval changing screen 1700 is displayed to a user, in a case where the monitoring interval of the application probe 23 is changed. According to this embodiment, the monitoring-interval changing screen 1700 is displayed on the display apparatus 7.

The monitoring-interval changing screen 1700 includes a display area 1710 and a display area 1720.

The display area 1710 displays a list of application probes 23 whose monitoring intervals are to be changed. A list of application probes 23 is displayed in the display area 1710. The list includes an application probe name 1711, a host 1712, and a monitoring interval 1713. The application probe name 1711 is the name of an application probe 23. The host 1712 is the name of a host 9 on which the application probe 23 operates. The monitoring interval 1713 displays the monitoring interval of the application probe 23. An increase/decrease button 1714 for changing the monitoring interval is also displayed in the monitoring interval 1713.

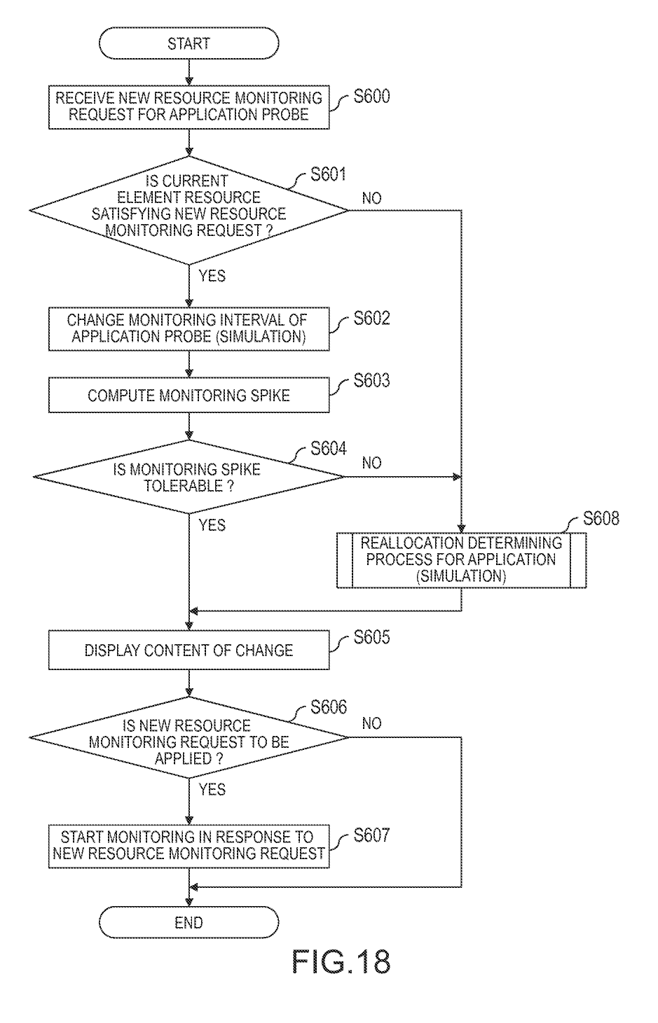

In a case where the user manipulates the increase/decrease button 1714, a new resource monitoring request is input to the management computer 1. In a case of receiving the resource monitoring request from the user, the probe managing program 16 performs the monitoring-interval changing process for the application probe 23 to adjust the probe environment. The monitoring-interval changing process for the application probe 23 is described later referring to FIG. 18.

The display area 1720 displays a change in a monitoring spike originating from a change in the monitoring interval of the application probe 23.

The display area 1720 displays a host 1721, a change content 1722, and a monitoring spike increase/decrease 1723.

The host 1721 is the name of a host 9. The change content 1722 represents the content of a change in probe environment originating from a change in the monitoring interval of the application probe 23. The monitoring spike increase/decrease 1723 represents an increase/decrease in monitoring spike originating from a change in the monitoring interval of the application probe 23.

An OK button 1730 is an operational button for reflecting the operational content of the monitoring-interval changing screen 1700. A cancel button 1740 is an operational button for canceling the operational content of the monitoring-interval changing screen 1700.

The user checks the value of the monitoring spike increase/decrease 1723. The user presses the OK button 1730 in a case of determining that there is no problem, and presses the cancel button 1740 in a case of determining that there is a problem.

FIG. 18 is a flowchart illustrating the monitoring-interval changing process for the application probe 23 that is performed by the management computer 1 according to the third embodiment.

In a case where the user presses the increase/decrease button 1714 in the display area 1710, a resource monitoring request including the name and the changed monitoring interval of the application probe 23 in the operated entry is input to the management computer 1.

In a case of receiving a new resource monitoring request for the application probe 23 in operation (Step S600), the management computer 1 calls the probe managing program 16 to start processing. The resource monitoring request includes the name and the monitoring interval of the application probe 23.

The probe managing program 16 updates the resource monitoring request information 50 based on the received resource monitoring request. The application probe 23 to be processed is referred to as the application probe A hereinafter.

The probe managing program 16 determines whether the element resource on which the application probe A currently operates satisfies the new resource monitoring request (Step S601). Specifically, the following process is performed.

The probe managing program 16 refers to the infrastructure configuration information 30 to retrieve such an entry that the operating application/operating probe 33 matches the name of the application probe A. The probe managing program 16 specifies the element resource on which the application probe A currently operates based on the element resource name 32 of the retrieved entry. Further, the probe managing program 16 specifies the resource monitoring probe 24 that operates on the specified resource.

The probe managing program 16 refers to the probe configuration information 60 to retrieve such an entry that the probe name 61 matches the name of the specified resource monitoring probe 24. The probe managing program 16 determines whether the value of the monitoring interval 64 in the retrieved entry is a divisor of the monitoring interval 55. In a case where the value of the monitoring interval 64 of the resource monitoring probe 24 is a divisor of the monitoring interval 55, it is determined that the element resource satisfies the new resource monitoring request.

In a case where it is determined that the element resource satisfies the new resource monitoring request, the probe managing program 16 simulates a change in the monitoring interval of the application probe 23 based on the new resource monitoring request (Step S602). Further, the probe managing program 16 computes a monitoring spike of the element resource, in a case where the monitoring interval of the application probe 23 is changed (Step S603). Because the method of computing a monitoring spike is identical to the one described in connection to Steps S202 to S204, its description is omitted.

The probe managing program 16 determines whether the monitoring spike is tolerable based on the size of the monitoring spike on the critical path (Step S604). The description of the process of Step S604 is omitted because the process is similar to the process of Step S205.

In a case where it is determined that the monitoring spike is tolerable, the probe managing program 16 proceeds to Step S605.

In a case where it is determined in Step S601 that the element resource does not satisfy the new resource monitoring request, or in a case where it is determined in Step S604 that the monitoring spike is not tolerable, the probe managing program 16 simulates the reallocation determining process for the application 22 (Step S608).

Although the simulation of the reallocation determining process for the application 22 is substantially identical to that in the second embodiment, it differs in that execution of the reallocation process is not really instructed in Steps S308 and S505, but the process result is output.

The probe managing program 16 displays the processing result in the display area 1720 of the monitoring-interval changing screen 1700 (Step S605).

Specifically, the probe managing program 16 generates information for displaying the results of processing in Steps S600 to S603 and Step S608, and outputs the information to the display apparatus 7. As a result, the processing results are displayed in the display area 1720 of the monitoring-interval changing screen 1700. After outputting the information for displaying the processing results, the probe managing program 16 stands by for an operation performed by the user.

The probe managing program 16 determines whether to apply the new resource monitoring request (Step S606). Specifically, it is determined whether the user has operated the OK button 1730.

In a case where it is determined that the new resource monitoring request is to be applied, the probe managing program 16 starts the monitoring process in accordance with the new resource monitoring request (Step S607), and then terminates the process. Specifically, the probe managing program 16 sets a new monitoring interval to the application probe 23.

In a case where it is determined that the new resource monitoring request is not to be applied, the probe managing program 16 terminates the process without applying the new resource monitoring request.

### Fourth Embodiment

There is a case where one wants to change the monitoring interval of an application probe 23 as a measure to detect occurrence of a failure early, but does not want to change the configurations of the application 22 and the application probe 23, in other words, a case where one does not want to change a host 9 on which the application 22 operates.

For example, a case where a performance failure occurs, but its cause is unknown corresponds to such a case. In the aforementioned case, the user may determine to wait for reoccurrence of a performance failure to specify the cause of the failure. To cause a performance failure to occur again, it is desired to maintain the current configuration, and it is not preferred to migrate the application 22 and the application probe 23 to another host 9.

In this respect, the monitoring interval of the application probe 23 is changed while maintaining the configuration. At this time, changing the monitoring interval, particularly, shortening the monitoring interval leads to an increase in monitoring spike, and hence maintaining the configuration and suppressing a monitoring spike in the tolerance range may not be achieved at the same time. In such a case, the user needs to increase the tolerance of a monitoring spike temporarily.

According to a fourth embodiment of this invention, in the case where the monitoring interval of the application probe 23 is changed while maintaining the configuration, the user's determination to increase the tolerance of a monitoring spike is supported. Specifically, in accordance with shortening of the monitoring interval of the application probe 23, the management computer 1 provides the user the estimated value of a monitoring spike, the necessity of increasing the tolerance of the monitoring spike, or the like.

The following describes the fourth embodiment focusing on the differences from the first embodiment.

Because the configuration of an IT system, the configuration of the management computer 1, and the configuration of the host 9 are identical to those of the first embodiment, their descriptions are omitted in the fourth embodiment. In addition, because the individual pieces of information held in the management computer 1 are identical to those of the first embodiment, their descriptions are likewise omitted.

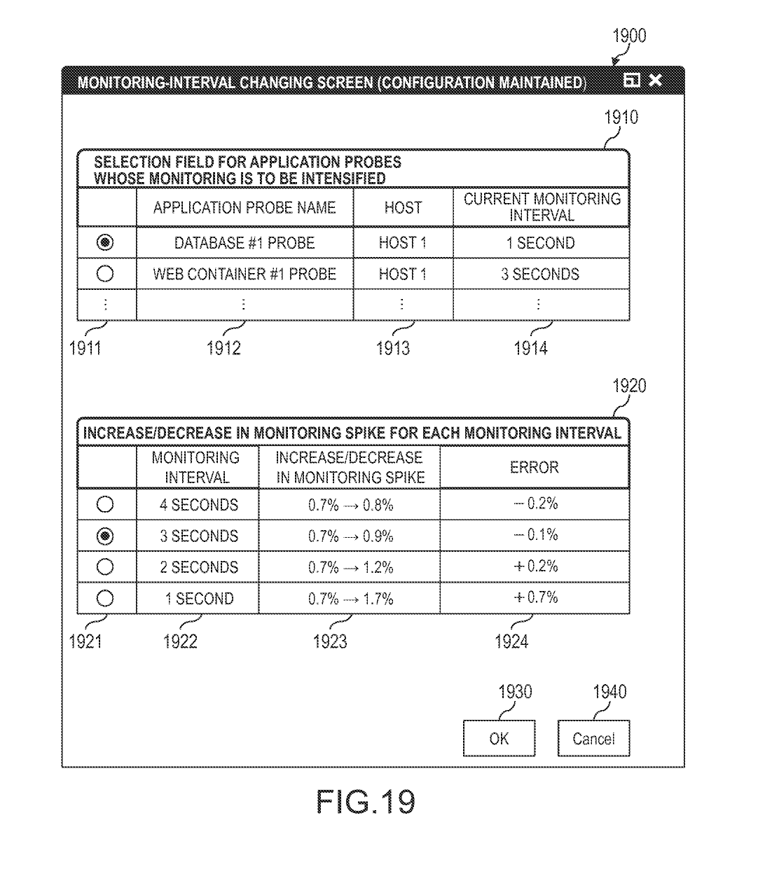

FIG. 19 is an explanatory diagram illustrating an example of a monitoring-interval changing screen 1900 according to the fourth embodiment.

The monitoring-interval changing screen 1900 is displayed to a user, in a case where the monitoring interval of the application probe 23 is changed. According to this embodiment, the monitoring-interval changing screen 1900 is displayed on the display apparatus 7.

The monitoring-interval changing screen 1900 includes a display area 1910 and a display area 1920.

The display area 1910 is a display area for selecting the application probe 23 whose monitoring is intensified. A list of application probes 23 is displayed in the display area 1910.

The list includes a selection radio button 1911, an application probe name 1912, a host 1913, and a current monitoring interval 1914. The selection radio button 1911 is a check field to select an application probe 23. The application probe name 1912 is the name of the application probe 23. The host 1913 is the name of a host 9 on which the application probe 23 operates. The current monitoring interval 1914 is the current monitoring interval of the application probe 23.

The list may display all the application probes 23, or may display only an application probe 23 that operates on a host 9 where a performance failure has occurred due to an unknown cause.

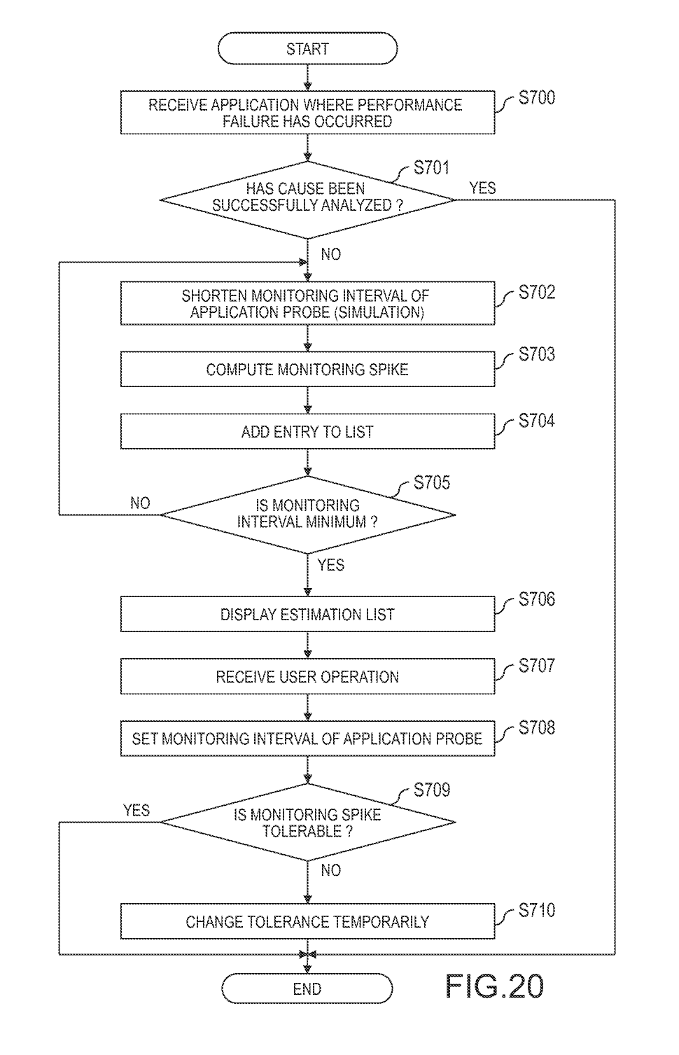

The user checks the selection radio button 1911 to select an application probe 23 whose monitoring is intensified. The probe managing program 16 displays a monitoring spike for the selected application probe 23, in a case where the monitoring interval thereof is changed, and performs a monitoring-interval changing process for the application probe 23 for changing the monitoring interval. The details of the display process are given later referring to FIG. 20.

The display area 1920 displays the result of the monitoring-spike display process. A list showing an increase/decrease in monitoring spike, in a case where the monitoring interval of the application probe 23 is shortened one level at a time, is displayed in the display area 1920. One level at a time indicates a unit for shortening the monitoring interval, which is assumed to be one second according to this embodiment.

The list includes a selection radio button 1921, a monitoring interval 1922, a monitoring-spike increase/decrease 1923, and an error 1924. The selection radio button 1921 is a check field to select a monitoring interval which is to be applied. The monitoring interval 1922 is the monitoring interval to be applied. The monitoring-spike increase/decrease 1923 represents a change in monitoring spike after the monitoring interval is changed. The error 1924 represents an error between the size of a monitoring spike after the monitoring interval is changed and the tolerance.

The user checks the selection radio button 1921 and selects the monitoring interval in consideration of information displayed in the display area 1920.

An OK button 1930 is an operational button for reflecting the operational content of the monitoring-interval changing screen 1900. A Cancel button 1940 is an operational button for canceling the operational content of the monitoring-interval changing screen 1900.

The user checks the value of the monitoring spike increase/decrease 1923. The user presses the OK button 1930 in a case of determining that there is no problem, and presses the Cancel button 1940 in a case of determining that there is a problem.

FIG. 20 is a flowchart illustrating the display process that is performed by the management computer 1 according to the fourth embodiment.

In a case where the user operates the selection radio button 1911 in the display area 1910, a process start instruction including the name of an application probe 23 is input to the management computer 1.

The probe managing program 16 receives the application 22 that is designated by the user and where a performance failure has occurred (Step S700).

The probe managing program 16 analyzes the cause of the performance failure occurred in the application 22. A known technology may be used for the method of analyzing a performance failure. For example, a method of determining whether the value of measured data of a computer resource is larger than a predetermined threshold may be available.

The probe managing program 16 determines from the result of the analysis whether the cause of the performance failure occurred in the application 22 has been analyzed (Step S701).

In a case where it is determined that the cause of the performance failure occurred in the application 22 has been analyzed, the probe managing program 16 terminates the process.

In a case where it is determined that the cause of the performance failure occurred in the application 22 cannot be analyzed, the probe managing program 16 simulates shortening of the monitoring interval of the application probe 23 by one level (Step S702). Specifically, the following process is performed.

The probe managing program 16 refers to the probe configuration information 60 to retrieve such an entry that the monitoring target name 63 matches the name of the application 22 to be analyzed. The probe managing program 16 obtains the name of the application probe 23 that monitors the application 22 to be analyzed from the probe name 61 of the retrieved entry, and obtains the monitoring interval of the application probe 23 from the monitoring interval 64 of the retrieved entry.

The probe managing program 16 performs simulation in which the obtained monitoring interval is shortened one level at a time. For example, in a case where the current monitoring interval is five seconds, simulation is performed of shortening the monitoring interval in the order of four seconds, three seconds, two seconds, and one second.

The probe managing program 16 computes a monitoring spike of the element resource, in a case where the monitoring interval of the application probe 23 is shortened (Step S703). Because the method of computing a monitoring spike is identical to the one described in connection to Steps S202 to S204, its description is omitted.

At this time, the probe managing program 16 refers to the probe restriction information 70 to obtain the tolerance from the monitoring spike 73 of an entry corresponding to the application probe 23. Further, the probe managing program 16 computes the value of the left-hand side of the monitoring spike 73 based on the monitoring spike, and computes the difference between the tolerance and the computed value as an error.

The probe managing program 16 adds the entry to an estimation list (Step S704). The estimation list represents a list to be displayed in the display area 1920. It should be noted that the estimation list is not displayed in the display area 1920 at this point of time.

Specifically, the probe managing program 16 sets the monitoring interval of the application probe 23 shortened to the monitoring interval 1922 in the added entry. The probe managing program 16 also sets values representing the size of the monitoring spike before changing the monitoring interval and the size of the monitoring spike after changing the monitoring interval to the monitoring spike increase/decrease 1923 in the added entry. Further, the probe managing program 16 sets the computed error to the error 1924 in the added entry.

The probe managing program 16 refers to the minimum monitoring interval 72 in the probe restriction information 70 to determine whether the shortened monitoring interval of the application probe 23 is larger than the value of the minimum monitoring interval 72 (Step S705).

In a case where it is determined that the shortened monitoring interval of the application probe 23 is larger than the value of the minimum monitoring interval 72, the probe managing program 16 returns to Step S702 to perform similar processing.

In a case where it is determined that the shortened monitoring interval of the application probe 23 is equal to or less than the value of the minimum monitoring interval 72, the probe managing program 16 displays the estimation list on the display apparatus 7 via the display I/F 5 (Step S706). Accordingly, the estimation list in the display area 1920 in the monitoring-interval changing screen 1900 is displayed. The user performs an operation to change the monitoring interval referring to the list.

In a case of receiving the user's operation (Step S707), the probe managing program 16 sets the monitoring interval to the application probe 23 based on the user's operation (Step S708).

Specifically, the user operates the selection radio button 1921 in the display area 1920 to input a monitoring-interval setting request to the management computer 1. The probe managing program 16 changes the monitoring interval currently set to the application probe 23 to the selected monitoring interval in response to the setting request.

The probe managing program 16 determines whether the monitoring spike is tolerable based on the size of the monitoring spike that is changed in accordance with a change in the monitoring interval of the application probe 23 (Step S709).

In a case where it is determined that the changed monitoring spike is tolerable, the probe managing program 16 terminates the process.

In a case where it is determined that the changed monitoring spike is not tolerable, the probe managing program 16 temporarily changes the size of the tolerable monitoring spike of the element resource (Step S709), and terminates the process.

Specifically, the probe managing program 16 sets the value computed in Step S703 to the tolerance of the monitoring spike 73 in the probe restriction information 70.

### Fifth Embodiment

The monitoring timing of the application probe 23 may deviate from the monitoring timing of the resource monitoring probe 24 with the time. In a case where the monitoring timing deviates, the correct status of the element resource when the performance of the application degrades is unknown. This interferes with the work of examining the details when a performance failure occurs.

According to a fifth embodiment of this invention, the management computer 1 detects a deviation between the monitoring timings of the resource monitoring probe 24 for each element resource and the application probe 23, and corrects the deviation of the monitoring timing.

The following describes the fifth embodiment focusing on the differences from the first embodiment.

Because the configuration of an IT system, the configuration of the management computer 1, and the configuration of the host 9 are identical to those of the first embodiment, their descriptions are omitted in the fifth embodiment. In addition, because the individual pieces of information held in the management computer 1 are identical to those of the first embodiment, their descriptions are likewise omitted.

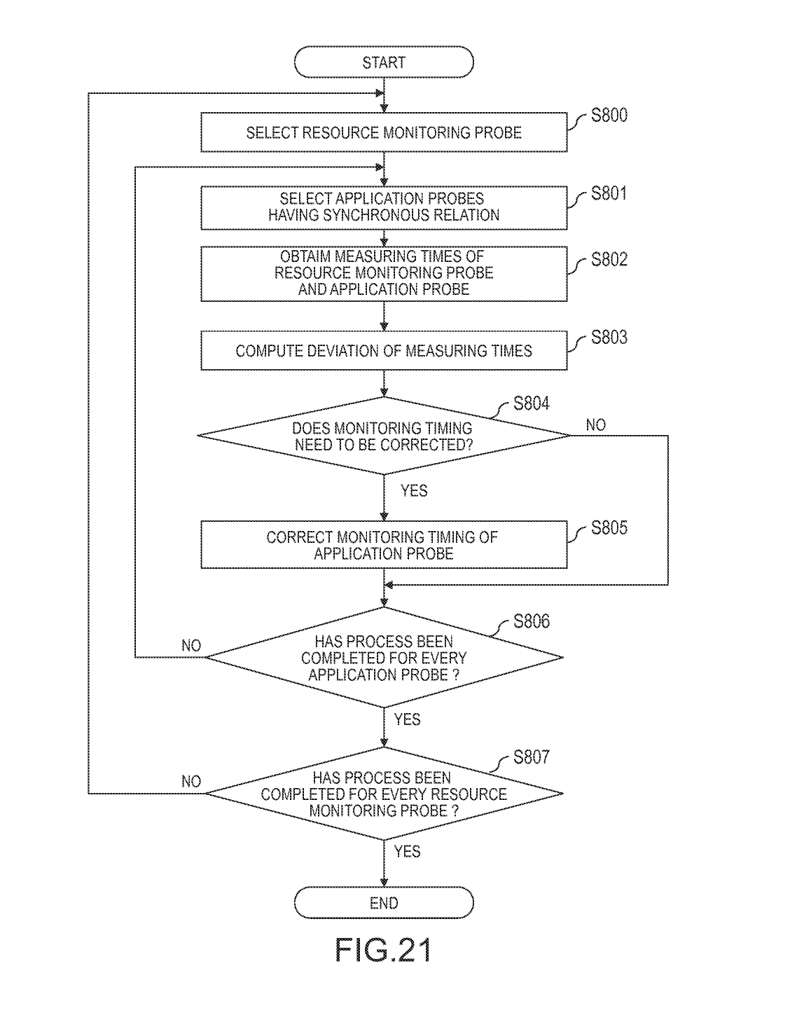

FIG. 21 is a flowchart illustrating a monitoring-timing correcting process that is performed by the management computer 1 according to the fifth embodiment.

The out-of-synchronization monitoring program 17 refers to the probe configuration information 60 to select one resource monitoring probe 24 to be processed (Step S800).

The out-of-synchronization monitoring program 17 selects one application probe 23 that has a synchronous monitoring relation with the resource monitoring probe 24 to be processed (Step S801).

Specifically, the out-of-synchronization monitoring program 17 refers to the probe monitoring timing information 80 to retrieve an entry whose resource monitoring probe name 81 matches the name of the selected resource monitoring probe 24. The out-of-synchronization monitoring program 17 selects one application probe 23 from application probes 23 stored in the application probe name 83 in the retrieved entry.

The out-of-synchronization monitoring program 17 obtains measuring times for the resource monitoring probe 24 and the application probe 23, respectively (Step S802).

Specifically, the out-of-synchronization monitoring program 17 retrieves, from the measured data information, an entry whose probe name 41 matches the name of the selected resource monitoring probe 24, and an entry whose probe name 41 matches the name of the selected application probe 23. The out-of-synchronization monitoring program 17 obtains measuring times for the resource monitoring probe 24 and the application probe 23 respectively from the measuring times 42 in the retrieved two entries.

The out-of-synchronization monitoring program 17 computes the deviation of the measuring time, in other words, the deviation of the monitoring timing, based on the measuring time for the resource monitoring probe 24 and the measuring time for the application probe 23 (Step S803).

Specifically, the out-of-synchronization monitoring program 17 statistically processes the difference between the measuring time for the resource monitoring probe 24 and the measuring time for the application probe 23, and stores the processing result in the out-of-synchronization statistical information 100. The out-of-synchronization statistical information 100 stores the average synchronization error 102 and the error standard deviation 103 for each application probe 23.

The probe managing program 16 determines whether correction of the monitoring timing is needed (Step S804).

Specifically, the out-of-synchronization monitoring program 17 determines based on the out-of-synchronization statistical information 100 whether the value indicating the synchronization error is larger than a predetermined threshold. For example, a determination method as expressed by an expression (1), an expression (2), or an expression (3) is available.

average synchronization error/monitoring interval of application probe>threshold (Expression 1)

standard deviation of synchronization error/monitoring interval of application probe>threshold (Expression 2)

synchronization error in the previous one week>standard deviation of synchronization error (Expression 3)

In a case where the expression (1), the expression (2), or the expression (3) is satisfied, the out-of-synchronization monitoring program 17 determines that correction of the monitoring timing is necessary.

In a case where it is determined that correction of the monitoring timing is unnecessary, the out-of-synchronization monitoring program 17 proceeds to Step S806.

In a case where it is determined that correction of the monitoring timing is necessary, the out-of-synchronization monitoring program 17 corrects the monitoring timing for the application probe 23 (Step S805), and then proceeds to Step S806.

Here, the out-of-synchronization monitoring program 17 quickens or delays the monitoring timing for the application probe 23 by the value of the average synchronization error 102 in the out-of-synchronization statistical information 100.

In a case where the average synchronization error 102 is “+10 milliseconds”, in other words, in a case where the monitoring timing for the application probe 23 is behind the monitoring timing for the resource monitoring probe 24 by 10 milliseconds, for example, the out-of-synchronization monitoring program 17 quickens the monitoring timing for the application probe 23 by 10 milliseconds. In a case where the average synchronization error 102 is “−10 milliseconds”, in other words, in a case where the monitoring timing for the application probe 23 is ahead of the monitoring timing for the resource monitoring probe 24 by 10 milliseconds, on the other hand, the out-of-synchronization monitoring program 17 delays the monitoring timing for the application probe 23 by 10 milliseconds.

The out-of-synchronization monitoring program 17 determines whether the process is completed for every application probe 23 having a synchronous monitoring relation with the resource monitoring probe 24 to be processed (Step S806).

In a case where it is determined that the process is not completed for every application probe 23, the out-of-synchronization monitoring program 17 returns to Step S801 to perform similar processing.

In a case where it is determined that the process is completed for every application probe 23, the out-of-synchronization monitoring program 17 determines whether the process is completed for every resource monitoring probe 24 (Step S807).

In a case where it is determined that the process is not completed for every resource monitoring probe 24, the out-of-synchronization monitoring program 17 returns to Step S800 to perform similar processing.

In a case where it is determined that the process is completed for every resource monitoring probe 24, the out-of-synchronization monitoring program 17 terminates the process.

### Sixth Embodiment

Although the first embodiment is premised on that the equation stored in the estimation equation 93 is provided beforehand, the equation may not be provided beforehand for a new probe, particularly, for a new application probe 23. Further, coefficients in the estimation equation may change with the time.

According to a sixth embodiment of this invention, the management computer 1 provides an estimation equation for a new probe, and periodically reexamines parameters in the existing estimation equation.

The following describes the sixth embodiment focusing on the differences from the first embodiment.

Because the configuration of an IT system, the configuration of the management computer 1, and the configuration of the host 9 are identical to those of the first embodiment, their descriptions are omitted in the sixth embodiment. In addition, because the individual pieces of information held in the management computer 1 are identical to those of the first embodiment, their descriptions are likewise omitted.

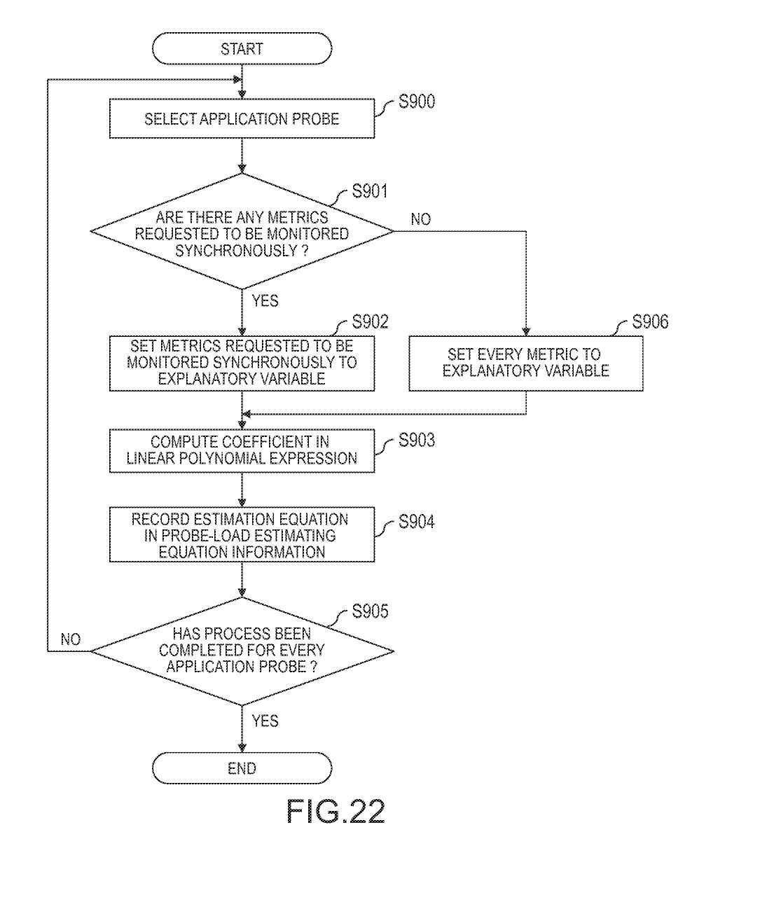

FIG. 22 is a flowchart illustrating an estimation-equation generating process that is performed by the management computer 1 according to the sixth embodiment.

In the estimation-equation generating process, the probe managing program 16 generates the estimation equation of the application probe 23 as a first-degree linear polynomial expression having the amount of computer resources used by the application 22 to be monitored as an explanatory variable.

The probe managing program 16 treats a metrics of element resources used for an explanatory variable as a metrics whose monitoring in synchronism with the resource monitoring probe 24 is requested by the application 22. Accordingly, all the matrices of the element resources are set as an explanatory variable, significantly reducing the amount of computation compared with that in a case of determining coefficients in the linear polynomial expression using a scheme such as the least squares method.

The probe managing program 16 refers to the probe configuration information 60 to select one application probe 23 to be processed (Step S900).

The probe managing program 16 refers to the resource monitoring request information 50 to determine whether there are metrics of the request resource requested to be monitored in synchronism with the application probe 23 to be processed (Step S901).

In a case where it is determined that there are metrics of the resource requested to be monitored in synchronism with the application probe 23 to be processed, the probe managing program 16 sets the metrics to an explanatory variable (Step S902), and then proceeds to Step S903.

In a case where it is determined that there are no metrics of the resource requested to be monitored in synchronism with the application probe 23 to be processed, the probe managing program 16 sets all the matrices in the resource (host 9) on which the application to be processed operates to explanatory variables (Step S906), and then proceeds to Step S903.

The probe managing program 16 refers to the measured data information 40 to compute coefficients in the linear polynomial expression having the metrics set as explanatory variables as variables (Step S903). According to this embodiment, the coefficients in the linear polynomial expression are determined using a scheme such as the least squares method.

The probe managing program 16 records the linear polynomial expression with the determined coefficients in the probe-load estimating equation information 90 as the estimation equation (Step S904).

Specifically, the probe managing program 16 records the linear polynomial expression in the estimation equation 93 in the entry corresponding to the application probe 23 to be processed, and records a date and time on which the linear polynomial expression is recorded in the update date/time 94.

The probe managing program 16 determines whether the process is completed for every application probe 23 (Step S905).

In a case where it is determined that the process is not completed for every application probe 23, the probe managing program 16 returns to Step S900 to perform similar processing.

In a case where it is determined that the process is completed for every application probe 23, the probe monitoring program 16 terminates the process.

It should be noted that various kinds of software exemplified in the embodiments can be stored in various recording media (for example, non-transitory storage medium) of an electromagnetic type, an electronic type, an optical type, and other such type, and can be downloaded onto the computer through a communication network such as the Internet.

Further, in the embodiments, the example of using the control in a software manner is described, but it is also possible to realize a part thereof in a hardware manner.

The embodiments have been described above in detail with reference to the accompanying drawings, but the embodiments are not limited to the above-mentioned specific configurations, and include various changes and similar configurations that fall within the scope of the attached claims.

1. A management computer for managing allocation of an application and an application probe for monitoring a status of the application in a computer system including a plurality of computers,
the plurality of computers including at least one computer on which a resource monitoring probe that monitors a status of at least one computer operates, the management computer comprising:
a processor;
a memory coupled to the processor;
a network interface coupled to the processor; and
a probe management part configured to determine a computer for allocating a new application and a new application probe requested to perform monitoring in synchronism with a monitoring timing for the resource monitoring probe, based on a monitoring request including a configuration condition for the computer for allocating the new application probe and a monitoring interval condition for the new application probe,
the probe management part being configured to:
retrieve a computer satisfying the configuration condition and the monitoring interval condition from among the plurality of computers;
compute a value of a monitoring spike, in a case where the new application and the new application probe are allocated to the retrieved computer, the monitoring spike being a load generated by the resource monitoring probe and the application probe for performing monitoring in synchronism with the monitoring timing for the resource monitoring probe;
determine whether the computed value of the monitoring spike is smaller than a predetermined threshold; and
determine the retrieved computer as a candidate computer to which the application and the application probe are to be allocated, in a case where it is determined that the computed value of the monitoring spike is smaller than the predetermined threshold.

2. The management computer according to claim 1, wherein:
the monitoring interval condition includes a monitoring interval which is a period for the new application probe to check the status of the application;
the management computer holds computer configuration information for storing information on a configuration of each of the plurality of computers, a resource monitoring probe for monitoring the each of the plurality computers, and the application probe which operates on the each of the plurality of computers, and probe configuration information for storing information on a monitoring interval of the resource monitoring probe and a monitoring target of the resource monitoring probe; and
the probe management part is further configured to:
retrieve a computer satisfying the configuration condition by referring to the computer configuration information;
obtain a monitoring interval of a resource monitoring probe for monitoring the retrieved computer by referring to the probe configuration information; and
compare a monitoring interval of the new application probe with the monitoring interval of the resource monitoring probe for monitoring the retrieved computer to determine whether the monitoring interval condition is satisfied.

3. The management computer according to claim 2, wherein the probe management part is further configured to:
determine whether the monitoring interval of the resource monitoring probe for monitoring the retrieved computer is a divisor of the monitoring interval of the new application probe; and
determine that the monitoring interval condition is satisfied, in a case where the monitoring interval of the resource monitoring probe for monitoring the retrieved computer is a divisor of the monitoring interval of the new application probe.

4. The management computer according to claim 2, wherein:
the management computer further holds monitoring timing information for storing the resource monitoring probe, an application probe for performing monitoring in synchronism with the monitoring timing for the resource monitoring probe, and a monitoring interval of the application probe; and
the probe management part is further configured to:
specify a combination of application probes, which perform monitoring in synchronism with the monitoring timing for the resource monitoring probe and whose monitoring timings are synchronized with each other, by referring to the monitoring timing information;
determine a monitoring timing of the new application probe based on the combination;
compute the value of the monitoring spike for each combination; and
determine whether a maximum value of the monitoring spike is smaller than the predetermined threshold.

5. The management computer according to claim 4, wherein:
the management computer further holds:
measured data information for storing measured data obtained by the resource monitoring probe and the application probe; and
estimation information for computing a load which is generated by the new application probe; and
the probe management part is further configured to:
compute values of monitoring spikes generated by the respective application probes included in the combination based on the measured data information and the estimation information; and
sum the values of the monitoring spikes generated by the respective application probes to compute the value of the monitoring spike of the combination.

6. The management computer according to claim 4, wherein the probe management part computes a number of the application probes included in the combination as the value of the monitoring spike of the combination.

7. The management computer according to claim 2, wherein the probe management part is further configured to:
retrieve a computer satisfying the configuration condition by referring to the computer configuration information, in a case where it is determined that the computed value of the monitoring spike is equal to or greater than the predetermined threshold;
compute a value of the monitoring spike, in a case where the monitoring interval of the resource monitoring probe for monitoring the retrieved computer is changed so as to satisfy the monitoring interval condition;
determine whether the computed value of the monitoring spike is smaller than the predetermined threshold;
change the monitoring interval of the resource monitoring probe for monitoring the retrieved computer, in a case where it is determined that the computed value of the monitoring spike is smaller than the predetermined threshold; and
determine the retrieved computer as a candidate computer to which the application and the application probe are to be allocated.

8. The management computer according to claim 2, wherein:
the management computer further holds measured data information for storing measured data obtained by the resource monitoring probe and the application probe; and
the probe management part is further configured to:
periodically compute a value of the monitoring spike for each of the resource monitoring probes for respectively monitoring the plurality of computers, based on the measured data information;
determine whether the computed value of the monitoring spike is smaller than the predetermined threshold;
retrieve a computer satisfying the configuration condition and the monitoring interval condition from among the plurality of computers, in a case where it is determined that the computed value of the monitoring spike is equal to or greater than the predetermined threshold;
compute a value of the monitoring spike in a case where the new application and the new application probe are allocated to the retrieved computer;
determine whether the computed value of the monitoring spike is smaller than the predetermined threshold; and
determine the retrieved computer as a candidate computer to which the application and the application probe are to be allocated, in a case where it is determined that the computed value of the monitoring spike is smaller than the predetermined threshold.

9. The management computer according to claim 2, wherein the probe management part is further configured to:
receive a change request for changing the monitoring interval of the application probe;
compute, in response to the received change request, a value of the monitoring spike, in a case where the monitoring interval of the application probe is changed;
determine whether the computed value of the monitoring spike is smaller than the predetermined threshold;
retrieve a computer satisfying the configuration condition and the monitoring interval condition from among the plurality of computers, in a case where it is determined that the computed value of the monitoring spike is equal to or greater than the predetermined threshold;
compute a value of the monitoring spike, in a case where the new application and the new application probe are allocated to the retrieved computer;
determine whether the computed value of the monitoring spike is smaller than the predetermined threshold;
determine the retrieved computer as a candidate computer to which the application and the application probe are to be allocated, in a case where it is determined that the computed value of the monitoring spike is smaller than the predetermined threshold; and
generate information for displaying the computed value of the monitoring spike and a content of a change in an allocation destination of the application probe.

10. The management computer according to claim 2, wherein the probe management part is further configured to:
receive a change request for changing the monitoring interval of the application probe;
compute, in response to the received change request, a value of the monitoring spike, in a case where the monitoring interval of the application probe is changed;
compute a difference between the computed value of the monitoring spike and the predetermined threshold;
generate information for displaying a value of the monitoring interval to be changed and the computed difference;
determine whether the computed value of the monitoring spike is smaller than the predetermined threshold; and
set the value of the monitoring spike as a new predetermined threshold, in a case where it is determined that the computed value of the monitoring spike is equal to or greater than the predetermined threshold.

11. The management computer according to claim 2, further comprising an out-of-synchronization monitoring part configured to monitor a deviation between monitoring timings of the resource monitoring probe and the application probe that performs monitoring in synchronism with the resource monitoring probe,
wherein the out-of-synchronization monitoring part is configured to:
compute the deviation between the monitoring timings of the resource monitoring probe and the application probe that performs monitoring in synchronism with the resource monitoring probe;
determine based on the computed deviation of the monitoring timings whether the monitoring timing of the application probe needs to be corrected; and
correct the monitoring timing of the application probe based on the computed deviation of the monitoring timings, in a case where it is determined that the monitoring timing of the application probe needs to be corrected.

12. An allocation management method for a management computer for managing allocation of an application and an application probe for monitoring a status of the application in a computer system including a plurality of computers,
the plurality of computers including at least one computer on which a resource monitoring probe that monitors a status of at least one computer operates,
the management computer comprising a processor, a memory coupled to the processor, and a network interface coupled to the processor,
the allocation management method including:
a first step of receiving, by the management computer, a monitoring request including a configuration condition for a computer for allocating a new application probe requested to perform monitoring in synchronism with a monitoring timing for the resource monitoring probe and a monitoring interval condition for the new application probe;
a second step of retrieving, by the management computer, a computer satisfying the configuration condition and the monitoring interval condition from among the plurality of computers;
a third step of computing, by the management computer, a value of a monitoring spike in a case where a new application and the new application probe are allocated to the retrieved computer, the monitoring spike being a load generated by the resource monitoring probe and the application probe for performing monitoring in synchronism with the monitoring timing for the resource monitoring probe;
a fourth step of determining, by the management computer, whether the computed value of the monitoring spike is smaller than a predetermined threshold; and
a fifth step of determining, by the management computer, the retrieved computer as a candidate computer to which the application and the application probe are to be allocated, in a case where it is determined that the computed value of the monitoring spike is smaller than the predetermined threshold.

13. The allocation management method according to claim 12, wherein:
the monitoring interval condition includes a monitoring interval which is a period for the new application probe to check the status of the application;
the management computer holds computer configuration information for storing information on a configuration of each of the plurality of computers, a resource monitoring probe for monitoring the each of the plurality of computers, and the application probe which operates on the each of the plurality of computers, and probe configuration information for storing information on a monitoring interval of the resource monitoring probe and a monitoring target of the resource monitoring probe; and
the second step includes:
retrieving a computer satisfying the configuration condition by referring to the computer configuration information;
obtaining a monitoring interval of a resource monitoring probe for monitoring the retrieved computer by referring to the probe configuration information;
determining whether the monitoring interval of the resource monitoring probe for monitoring the retrieved computer is a divisor of the monitoring interval of the new application probe; and
determining that the monitoring interval condition is satisfied in a case where the monitoring interval of the resource monitoring probe for monitoring the retrieved computer is a divisor of the monitoring interval of the new application probe.

14. The allocation management method according to claim 13, wherein:
the management computer further holds monitoring timing information for storing the resource monitoring probe, an application probe for performing monitoring in synchronism with the monitoring timing for the resource monitoring probe, and a monitoring interval of the application probe;
the third step includes:
specifying a combination of application probes, which perform monitoring in synchronism with the monitoring timing for the resource monitoring probe and whose monitoring timings are synchronized with each other, by referring to the monitoring timing information;
determining a monitoring timing of the new application probe based on the combination; and
computing the value of the monitoring spike for each combination; and
the fourth step includes determining whether a maximum value of the monitoring spike is smaller than the predetermined threshold.

15. A non-transitory computer readable storage medium having stored thereon a program which is executed by a management computer for managing allocation of an application and an application probe for monitoring a status of the application in a computer system including a plurality of computers,
the plurality of computers including at least one computer on which a resource monitoring probe that monitors a status of at least one computer operates,
the management computer including a processor, a memory coupled to the processor, and a network interface coupled to the processor,
the program causing the management computer to perform the procedures of:
receiving a monitoring request including a configuration condition for a computer for allocating a new application probe requested to perform monitoring in synchronism with a monitoring timing for the resource monitoring probe and a monitoring interval condition for the new application probe;
retrieving a computer satisfying the configuration condition and the monitoring interval condition from among the plurality of computers;
computing a value of a monitoring spike in a case where the new application and the new application probe are allocated to the retrieved computer, the monitoring spike being a load generated by the resource monitoring probe and the application probe for performing monitoring in synchronism with the monitoring timing for the resource monitoring probe;
determining whether the computed value of the monitoring spike is smaller than a predetermined threshold; and
determining the retrieved computer as a candidate computer to which the application and the application probe are to be allocated, in a case where it is determined that the computed value of the monitoring spike is smaller than the predetermined threshold.
